(19) United States
(12) Patent Application Publication
(10) Pub. No.: US 2024/0424739 A1
(43) Pub. Date: Dec. 26, 2024

(54) BUILD PLATE POSE CONTROL

(71) Applicant: VulcanForms Inc., Burlington, MA (US)

(72) Inventor: Raghav Aggarwal, Somerville, MA (US)

(73) Assignee: VulcanForms Inc., Burlington, MA (US)

(21) Appl. No.: 18/750,543

(22) Filed: Jun. 21, 2024

Related U.S. Application Data
(60) Provisional application No. 63/509,935, filed on Jun. 23, 2023.

(51) Int. Cl. B29C 64/393; B29C 64/153; B29C 64/194; B29C 64/214; B29C 64/232; B29C 64/236; B29C 64/241; B29C 64/245; B29C 64/268; B33Y 10/00; B33Y 30/00; B33Y 40/00; B33Y 50/02

(52) U.S. Cl. CPC B29C 64/393; B29C 64/153; B29C 64/194; B29C 64/214; B29C 64/232; B29C 64/236; B29C 64/241; B29C 64/245; B29C 64/268; B33Y 10/00; B33Y 30/00; B33Y 40/00; B33Y 50/02

(57) ABSTRACT

A system may include a build plate aligned with a build plate plane and at least one build plate actuator operatively coupled to the build plate and configured to change a pose of the build plate plane. The build plate may be configured to receive a layer of material. One or more distance sensors may be configured to obtain build plate distance information including a relative distance between a reference frame of an optics assembly and the build plate and/or the build surface of the layer of material. At least one processor may be configured to receive the build plate and/or build surface distance information from the one or more distance sensors, and command the at least one build plate actuator to adjust the pose of the build plate plane based at least partly on the build plate and/or build surface distance information.

### RELATED APPLICATIONS

This application claims priority under 35 U.S.C. § 119 (e) to U.S. Provisional Application No. 63/509,935, filed Jun. 23, 2023, the content of which is incorporated by reference in its entirety for all purposes.

### FIELD

Disclosed embodiments are generally related to methods and apparatus for adjusting a pose of a build plate and build surface for additive manufacturing.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources to create a desired two-dimensional geometry of solidified material within the layer. Next, the build surface may be indexed, and another layer of precursor material may be deposited. For example, in conventional systems, the build surface may be indexed downwardly by a distance corresponding to a thickness of a layer. This process may be repeated layer-by-layer to fuse many two-dimensional layers into a three-dimensional object.

### SUMMARY

In some aspects, the techniques described herein relate to an additive manufacturing system including: a build plate aligned with a build plate plane; at least one build plate actuator operatively coupled to the build plate and configured to change a pose of the build plate plane; one or more laser energy sources; an optics assembly operatively movable in at least a first degree of freedom relative to the build plate, wherein the optics assembly is configured to direct laser energy from the one or more laser energy sources toward the build plate to melt at least a portion of a layer of material disposed on the build plate; a recoater blade operatively movable in at least the first degree of freedom relative to the build plate, wherein the recoater blade is configured to smooth a build surface of the layer of material disposed on the build plate; one or more distance sensors configured to obtain build plate distance information including a relative distance between a reference frame of the optics assembly and the build plate; and at least one processor configured to: receive the build plate distance information from the one or more distance sensors, and command the at least one build plate actuator to adjust the pose of the build plate plane based at least partly on the build plate distance information.

In some aspects, the techniques described herein relate to a method for additive manufacturing including: obtaining, with one or more distance sensors, build plate distance information including a relative distance between a reference frame of an optics assembly and a build plate; commanding, with at least one processor, at least one build plate actuator operatively coupled to the build plate to adjust a pose of a build plate plane aligned with the build plate based at least partly on the build plate distance information; depositing a layer of material on the build plate; moving a recoater blade operatively in a first degree of freedom relative to the build plate to smooth a build surface of the layer of material disposed on the build plate; moving the optics assembly in the first degree of freedom relative to the build plate; and directing laser energy from one or more laser energy sources toward the build plate to melt at least a portion of the layer of material disposed on the build plate.

In some aspects, the techniques described herein relate to an additive manufacturing system including: a build plate aligned with a build plate plane, wherein the build plate is configured to receive a layer of material; at least one build plate actuator operatively coupled to the build plate and configured to change a pose of the build plate plane; one or more laser energy sources; an optics assembly movable in at least a first degree of freedom relative to the build plate, wherein the optics assembly is configured to direct laser energy from the one or more laser energy sources toward the build plate to melt at least a portion of the layer of material disposed on the build plate; a recoater blade movable in at least the first degree of freedom relative to the build plate, wherein the recoater blade is configured to smooth a build surface of the layer of material disposed on the build plate; one or more distance sensors configured to obtain build surface distance information including a relative distance between a reference frame of the optics assembly and a build surface of the layer of material; and at least one processor configured to: receive the build surface distance information from the one or more distance sensors, and command the at least one build plate actuator to adjust the pose of the build plate plane based at least partly on the build surface distance information.

In some aspects, the techniques described herein relate to a method for additive manufacturing including: depositing a layer of material on a build plate; moving a recoater blade in a first degree of freedom relative to the build plate to smooth a build surface of the layer of material disposed on the build plate; obtaining, with one or more distance sensors, build surface distance information including a relative distance between a reference frame of an optics assembly and the build surface; commanding, with at least one processor, at least one build plate actuator operatively coupled to the build plate to adjust a pose of a build plate plane aligned with the build plate based at least partly on the build surface distance information; moving the optics assembly in the first degree of freedom relative to the build plate; and directing laser energy from one or more laser energy sources toward the build plate to melt at least a portion of the layer of material disposed on the build plate.

In some aspects, the techniques described herein relate to a method for additive manufacturing including: obtaining, with one or more distance sensors, deck distance information including a relative distance between a reference frame of an optics assembly and a deck surface; adjusting a first height of a first end of a recoater blade based on the deck distance information; adjusting a second height of a second opposing end of the recoater blade based on the deck distance information; and locking the recoater blade in position relative to the reference frame after adjusting the first height and the second height such that a lower edge of the recoater blade is disposed in a focus volume of the optics assembly.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a schematic representation of an additive manufacturing system according to some embodiments;

FIG. 2 shows the optical paths present in an additive manufacturing system according to some embodiments;

FIG. 3 shows a front view schematic of an additive manufacturing system according to some embodiments;

FIG. 4 shows a top view schematic of the additive manufacturing system of FIG. 3;

FIG. 5 shows a front view schematic of an additive manufacturing system according to some embodiments during a recoater blade adjustment process;

FIG. 6 shows a recoater blade of an additive manufacturing system according to some embodiments;

FIG. 7 shows an example of a focus volume and pose of a lower blade edge according to some embodiments;

FIG. 8 shows a block diagram for a method of operating an additive manufacturing system according to some embodiments;

FIG. 9 shows a front view schematic of an additive manufacturing system according to some embodiments during a build plate adjustment process;

FIG. 10 shows a side view schematic of the additive manufacturing system of FIG. 9 during a build plate adjustment process;

FIG. 11 shows a perspective example of a focus volume and pose of a build plate plane and blade of an additive manufacturing system according to some embodiments;

FIG. 12 shows a side view of the focus volume and pose of a build plate plane of FIG. 11;

FIG. 13 shows a perspective example of a focus volume and a build surface of a material layer after smoothing by a recoater blade according to some embodiments;

FIG. 14 shows a side view of the focus volume and material layer of FIG. 13;

FIG. 15 shows a perspective example of a focus volume and a build surface of a material layer after smoothing by a recoater blade according to some embodiments;

FIG. 16 shows a side view of the focus volume and material layer of FIG. 15;

FIG. 17 shows a block diagram for a method of operating an additive manufacturing system according to some embodiments;

FIG. 18 shows a further block diagram for the method of operating an additive manufacturing system according to FIG. 17;

FIG. 19 shows a block diagram for a method of operating an additive manufacturing system according to some embodiments;

FIG. 20 shows a further block diagram for the method of operating an additive manufacturing system according to FIG. 19; and

FIG. 21 shows a further block diagram for the method of operating an additive manufacturing system according to FIG. 19.

### DETAILED DESCRIPTION

A common issue in additive manufacturing systems is ensuring that the build surface is suitably level or otherwise oriented during a manufacturing process so that layers of precursor material can be successively deposited in uniform thickness on the build surface. That is, additive manufacturing products are made by fusing together portions of multiple layers of precursor material, and a build surface that is not level or otherwise properly oriented can result in deposited layers of precursor material having unequal and/or variable thicknesses, which can cause the resulting fused product to have incorrect dimensions or tolerances. Furthermore, layers with unequal thicknesses may find that the laser energy provided by the system is not suitable to melt thicker portions of a layer and/or may melt too much material and/or overheat the melt pool both of which may lead to the formation of part defects. Correspondingly, unfused portions of a layer corresponding to layers that are too thick may also cause part defects in the form of voids, delaminations, and/or other types of defects in the final product. Currently, leveling or other adjustment in the pose of a build surface requires human intervention and may be achieved by employing jack screws and/or shims to manually level the build surface. Human intervention in a leveling process is inefficient, e.g., because of the time involved in the leveling process and/or to make the build area safe for human presence. For example, build areas may be evacuated or purged of air so that an inert atmosphere can be established around the build surface (e.g., to reduce the likelihood of introducing impurities into a finished part). Also, the manufacturing process can generate significant heat, which may be required to dissipate before a human can safely approach a build area. Thus, the inventors have recognized a need for an additive manufacturing system capable of adjusting a pose of the build surface in an automated way that improves accuracy and reliability of manufacturing process.

The inventors have also appreciated the benefits of an additive manufacturing system that adjusts a pose (e.g., position and orientation) of a build plate to ensure a build surface of a layer of material disposed on the build plate is within a target three-dimensional volume of an optics assembly of the additive manufacturing system. In some embodiments, an optics assembly may have a narrow focus volume in which energy is focused to appropriately melt the material. In some cases, the target three-dimensional volume may have a height relative to the level of the nominal build surface of about 1 mm (+/−500 microns) though other target volumes within which the laser energy pixels of a system may be in focus are also possible. If a build surface is not flat or level relative to the reference frame of the optics assembly such that a portion of the build surface is not disposed in the target three-dimensional volume, the resulting part may fail or otherwise have diminished quality. Accordingly, the inventors have appreciated the benefits of an additive manufacturing system that adjusts a pose of the build plate to ensure a build surface is disposed entirely within the target three-dimensional focus volume of the optics assembly. In particular, the inventors have appreciated the benefits of a system that is capable of determining and adjusting the pose of the build plate to ensure the build surface is disposed within the target three-dimensional volume, and further alerting a user if the build surface is not able to be positioned within the target three-dimensional volume. Additionally, the inventors have appreciated the benefits of a system that automatically adjusts a pose of the build plate to ensure an entire thickness of a topmost material layer disposed on the build plate during operation is disposed within the target three-dimensional volume. For example, in some embodiments, during initialization of a system and/or part printing operation, the build plate may be controlled so that a build plate plane aligned with an uppermost surface of the build plate and the build surface are both disposed in the target three-dimensional volume.

The inventors have also appreciated the benefits of an additive manufacturing system that adjusts a pose of a build plate to ensure a layer of material disposed on the build plate has a uniform thickness. As noted above, deposited layers of precursor material having unequal and/or variable thicknesses may cause a resulting product to have incorrect dimensions or tolerances. Furthermore, layers with unequal thicknesses may have different melting characteristics, and if a layer is too thick or too thin it may result in various types of defects. An optics assembly may be configured to melt a predetermined thickness of material, such that varying thickness generally reduces product quality and/or may cause product failure. For example, unfused portions of a layer can cause voids and/or delaminations within the final product. Accordingly, the inventors have appreciated the benefits of an additive manufacturing system including a build plate may be moved by at least one build plate actuator to adjust a pose of the build plate to ensure that the thickness of a layer of material deposited on the build plate is consistent. In particular, the inventors have appreciated the benefits of a system that adjusts a pose of the build plate such that the build plate is parallel to a recoater blade of the additive manufacturing system.

The inventors have also appreciated that additive manufacturing systems typically employ build plates that are changed for each product, or set of products, additively built on the build plate. Build plates used with an additive manufacturing system may have variations in tolerances or other differences that result in a difference in pose between build plates when attached to an additive manufacturing system. Accordingly, the inventors have appreciated the benefits of an additive manufacturing system that can automatically register a build plate to a reference frame of the additive manufacturing system (e.g., a reference frame of an optics assembly). Moreover, the inventors have appreciated the benefits of a system that may adjust a pose of the build plate after being attached to the additive manufacturing system to ensure a layer of precursor material deposited on the build plate is positioned within a target three-dimensional volume, for the reasons discussed above. Such an arrangement eliminates manual leveling and adjustment currently implemented in additive manufacturing systems for build plates.

The inventors have also appreciated that additive manufacturing systems employ recoater blades that are configured to smooth a build surface of a material layer disposed on a build plate. The recoater blade may be a replaceable component that is manually installed by a user of the additive manufacturing system. In some cases, different recoater blades have different tolerances and variations that may result in a different pose of the recoater blade with respect to a reference frame of the additive manufacturing system, which may include a difference in a normal direction between upper surface of the build plate and the build surface corresponding to an upper exposed surface of the layer of precursor material disposed on the build plate during operation. Additionally, as the recoater blade may be installed manually, different recoater blades may have differences in pose with respect to a reference frame of the additive manufacturing system due to differences in installation by the user. Accordingly, the inventors have recognized the benefits of an additive manufacturing system that provides feedback to a user installing a recoater blade. Specifically, the inventors have recognized the benefit of a system configured to register a deck of the additive manufacturing system relative to a reference frame of an optics assembly and provide feedback to a user for adjusting a pose of the recoater blade. A user may install a recoater blade with more information to ensure the recoater blade is level with respect to the deck and the reference frame of the additive manufacturing system, so that any material smoothed by the recoater blade has an even thickness and is disposed within a target three-dimensional volume.

In some embodiments, an additive manufacturing system includes one or more distance sensors configured to measure a relative distance between a reference frame of the additive manufacturing system and one or more other components of the manufacturing system. In some embodiments, the one or more distance sensors may be configured to measure a relative distance between one or more other components and a reference frame of an optics assembly. The distance information from the one or more distance sensors may be employed to adjust the pose of the one or more components of the additive manufacturing system. For example, distance information measured to a build plate plane may be employed to adjust a pose of the build plate with respect to the reference frame. As another example, distance information measured to a build surface of a layer of material disposed on the build plate may be employed to adjust a pose of the build plate (and indirectly, the pose of the build surface) with respect to the reference frame. As still another example, distance information measured to a deck adjacent a build plate may be employed to register the position of the deck to the reference frame, and provide feedback to a user installing a recoater blade on the additive manufacturing system. In some embodiments, the one or more distance sensors may be disposed on an optics assembly, and may be configured to move relative to a build plate. For example, the one or more distance sensors may be configured to move at least in a first degree of freedom and a second degree of freedom perpendicular to the first degree of freedom. The one or more distance sensors may be configured to collect distance information in a vertical direction and further collect the distance measurements across a two-dimensional plane, with the measured distance being representative of the position of the third dimension (e.g., vertical dimension). A plurality of distance measurements may be employed according to exemplary embodiments herein to provide the benefits discussed above. In some embodiments, one or more distance sensors may include a single point distance sensor such as a laser rangefinder. In some embodiments, one or more distance sensors may include a LiDAR scanner, three-dimensional camera, or other sensor configured to measure a plurality of points are the same time. In some embodiments one or more distance sensors may include a plurality of single point distance sensors in fixed positions relative to reference frame of the additive manufacturing system. Of course, any single distance sensor or combination of distance sensors may be employed, as the present disclosure is not so limited.

In some embodiments, an additive manufacturing system includes one or more build plate actuators configured to support a build plate and move the build plate to adjust a pose of the build plate. The at least one build plate actuator may be configured to provide multiple degrees of freedom of adjustment of the build plate to allow the pose of the build plate to be adjusted within three-dimensional space. For example, the build plate may be adjusted to provide the benefits described above, including adjusting the vertical position and/or orientation of the build plate to ensure the build plate is in the desired position with respect to the reference frame of the additive manufacturing system. In some embodiments, the at least one build plate actuator may be configured to move the build plate in a vertical direction (e.g., a first translational degree of freedom) and two rotational degrees of freedom (e.g., pitch and roll). Any suitable mechanical arrangement for coupling the at least one actuator to the build plate for pose adjustment may be employed. For example, the at least one build plate actuator may be three linear actuators aligned with a vertical direction spaced on the build plate to allow for vertical translation, pitch, and roll adjustment. As another example, at least one actuator may include one vertical actuator and two rotational actuators. As still yet another example, at least one actuator may include two vertical actuators and one rotational actuator. Actuators may include motors, servos, linear actuators, or any other suitable form of actuator, as the present disclosure is not so limited.

In some embodiments, a method of operating an additive manufacturing system includes obtaining build plate distance information with one or more distance sensors. The build plate distance information may include relative distance(s) between a reference frame of an optics assembly of the additive manufacturing system and the build plate. For example, the one or more distance sensors may be configured to measure a vertical distance between the reference frame of the optics assembly (or a local reference frame registered to the reference frame of the optics assembly) and the build plate. The additive manufacturing system may use the build plate distance information to determine a location of a build plate plane in three-dimensional space. The build plate plane may be aligned with an uppermost surface facing the optics assembly and one or more distance sensors. For example, a plane may be fit to a plurality of distance measurements measured by the one or more distance sensors which is representative of the build plate plane. The fit plane may be employed to register the pose of the build plate to the reference frame of the optics assembly. The method may further include comparing the fit plane to a target three-dimensional volume. In some embodiments, the target three-dimensional volume may be a rectangular prism that is representative of a focus volume for the optics assembly. In some such embodiments, the focus volume may be a volume in which a material may be accurately melted by the optics assembly to form a product as a part of an additive manufacturing process. The method may further include moving the build plate with at least one build plate actuator to adjust the pose of the build plate plane. For example, the additive manufacturing may position the build plate plane so that a build surface of a material placed on the build plate plane is in the target three-dimensional volume. The build surface may be an uppermost surface of the layer of material facing the optics assembly and one or more distance sensors. In some embodiments, adjusting the pose of the build plate may include rotating the build plate in a first degree of freedom (e.g., pitch) and a second degree of freedom (e.g., roll). In some embodiments, adjusting the pose of the build plate may include translating the build plate in a vertical direction (e.g., along a z-axis).

In some embodiments, a method of operating an additive manufacturing system includes obtaining build surface distance information with one or more distance sensors. The build surface distance information may include relative distance(s) between a reference frame of an optics assembly of the additive manufacturing system and an uppermost surface of a layer of precursor material disposed on a build plate. For example, the one or more distance sensors may be configured to measure a vertical distance between the reference frame of the optics assembly (or a local reference frame registered to the reference frame of the optics assembly) and the build surface. The additive manufacturing system may use the build surface distance information to determine a location of a build surface in three-dimensional space. For example, a plane may be fit to a plurality of distance measurements measured by the one or more distance sensors which is representative of the build surface. Appropriate fitting methods for fitting a plane to the point cloud of correlated vertical distance and position information from the one or more distance sensors may include, but are not limited to, least squares, iterative methods such as random sample consensus (RANSAC), or singular value decomposition to find the singular vector with the least singular value. The fit plane may be employed to register the pose of the build surface to the reference frame of the optics assembly. The method may further include comparing the fit plane to a target three-dimensional volume. As discussed above, in some embodiments the target three-dimensional volume may be a rectangular prism that is representative of a focus volume for the optics assembly. In some such embodiments, the focus volume may be a volume in which the material may be melted by the optics assembly to form a product as a part of an additive manufacturing process. The method may further include moving the build plate with at least one build plate actuator to adjust the pose of the build surface so that the build surface is disposed within the target three-dimensional volume. In some embodiments, the method may further include positioning the build plate so that the layer of material has a uniform thickness across the build plate. In some such embodiments, the method may include adjusting a pose of the build surface so that the build plate is parallel to a recoater blade of the additive manufacturing system, such that when a layer of material is smoothed by the recoater blade the layer will have a uniform thickness. In some embodiments, the method may include positioning the build plate so that an entire thickness of the layer of material disposed in the target three-dimensional volume. According to some such embodiments, a build plate plane and a build surface may be placed within the target three-dimensional volume.

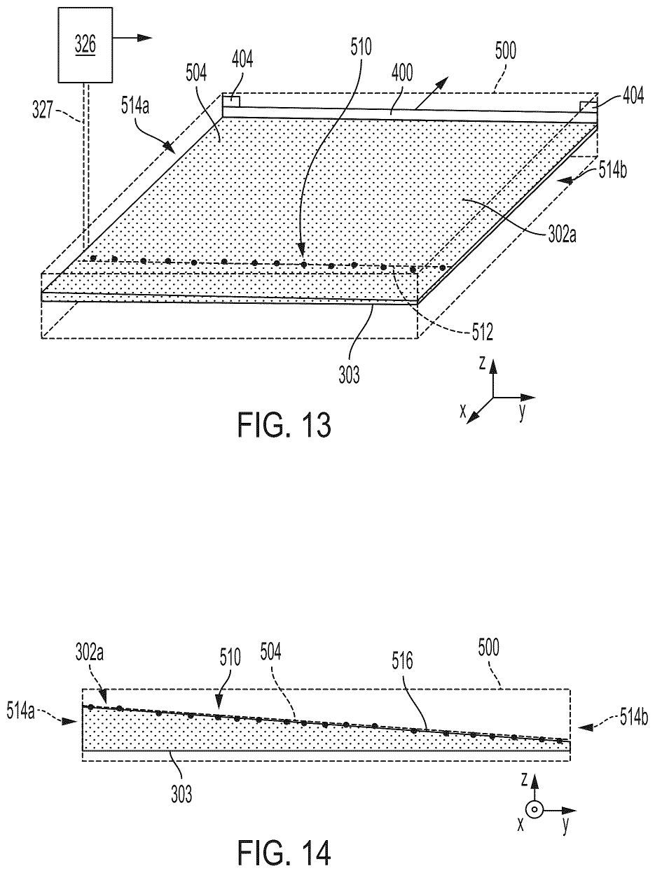

In some embodiments, an additive manufacturing system may include motion stages for various components, such as an optics assembly, build plate, and recoater blade. In some embodiments, an additive manufacturing system may include a horizontal motion stage (e.g., a rail) or other motion stage that is configured to provide a first degree of freedom for both the recoater blade and the optics assembly such that the recoater blade and the optics assembly may move parallel to a common direction of motion along the associated motion stage (e.g., in a horizontal direction parallel to a build plate's upper exposed surface and/or a build surface of the system). Of course, other types of motion stages including various types of support arrangements capable of providing the desired motion may be used including rods, rails, channels, wheels, linear bearings, and others may be used with various types of actuators including linear motors, stepper motors, motor and transmission combinations, belt driven systems, and/or any other appropriate type of actuator capable of driving the associated motion stage. That is, the recoater blade and the optics assembly may be operatively coupled to the same rail or other motion stage, such that they share a degree of freedom. In this manner, the recoater blade need not be separately registered to a reference frame of the optics assembly at least with respect to the shared degree of freedom. Additionally, according to some embodiments herein, sharing a motion stage may simplify the processing of distance measurements from one or more distance sensors (for example, see FIGS. 13-16). In some embodiments, the optics assembly may include a second motion stage configured to provide a second degree of freedom perpendicular to the first degree of freedom. According to some such embodiments, the optics assembly may be movable within a two-dimensional plane (e.g., along x and y axes). In some embodiments, one or more distance sensors may be disposed on the optics assembly, such that at least one of the one or more distance sensors moves with the optics assembly. According to some such embodiments, the optics assembly may be moved to obtain distance information at different locations within the two-dimensional plane provided by the motion stages. As discussed with reference to exemplary embodiments herein, such information may be employed to determine the pose of a plane of a build surface and/or build plate plane in three-dimensional space with respect to the reference frame of the optics assembly.

In some embodiments, a method of installing a recoater blade on an additive manufacturing system includes obtaining deck distance information with one or more distance sensors. The deck may be a surface adjacent a build plate. The deck distance information may include distances measured with respect to a reference frame of an optics assembly of the additive manufacturing system. In some embodiments, the deck distance information may be fit to a deck plane representative of an uppermost surface of the deck facing the optics assembly and one or more distance sensors. Based on the fit plane, the pose of the deck plane may be registered to the reference frame of the optics assembly. Based on the pose of the deck plane, the method may include determining a first height adjustment for a first end of a recoater blade and a second height adjustment for a second end of the recoater blade. The height adjustments may provide for a pose of the recoater blade that is parallel to the deck plane and at an appropriate height to clear the deck while providing smoothing of a build surface of material disposed on the adjacent build plate. In some embodiments, the method may include adjusting the height of the recoater blade according to the determined first and second height adjustments and locking the recoater blade in position after making the height adjustments. In some embodiments, a lower edge of the recoater blade may be positioned within a target three-dimensional volume (e.g., a focus volume of the optics assembly). Such an arrangement may ensure material smoothed by the recoater blade is also within the target three-dimensional volume.

According to exemplary embodiments described herein, an additive manufacturing system may be operated by a controller. The controller may include at least one processor configured to execute computer readable instructions stored in volatile or non-volatile memory. Methods described herein may be performed by at least one processor of an additive manufacturing system. The at least one processor may communicate with one or more actuators associated with various elements of the additive manufacturing system (e.g., motion stages, at least one build plate actuator, etc.) to control movement of the various components. The at least one processor may receive information from one or more sensors that provide feedback regarding the various components of the additive manufacturing system. For example, the at least one processor may receive position information regarding a distance sensor, optics assembly, build plate, and recoater blade. In this manner, the at least one processor may implement proportional control, integral control, derivative control, or a combination thereof (e.g., PID control). Of course, other feedback control schemes are contemplated, and the present disclosure is not limited in this regard. Any suitable sensors in any desirable quantities may be employed to provide feedback information to the at least one processor. Accelerometers, rotary encoders, potentiometers, optical sensors, and cameras may be employed in coordination with desirable processing techniques. The at least one processor may also communicate with other controllers, computers, or processors on a local area network, wide area network, or internet using an appropriate wireless or wired communication protocol. In some embodiments, a at least one processor may execute computer readable instructions based at least in part on input from a user. For example, a at least one processor may receive instructions from a user including a series of actions to be executed by the additive manufacturing system.

In some embodiments, incident laser spots on a build surface may be arranged in a line with a long dimension and a short dimension, or in an array. In either case, according to some aspects, a line, or array, of incident laser energy consists of multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Depending on the application, output of the optics assembly may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may include an optics head that is associated with one or more appropriate actuators configured to translate the optics head in a direction parallel to a plane of the build surface to scan the one or more laser pixels across the build surface. In either case, it should be understood that the disclosed systems and methods are not limited to any particular construction for scanning the laser energy across a build surface of the additive manufacturing system.

For the sake of clarity, transmission of laser energy through an optical fiber is described generically throughout. However, with respect to various parameters such as transverse cross-sectional area, transverse dimension, transmission area, power area density, and/or any other appropriate parameters related to a portion of an optical fiber that the laser energy is transmitted through, it should be understood that these parameters refer to either a parameter related to a bare optical fiber and/or a portion of an optical fiber that the laser energy is actively transmitted through such as an optical fiber core, or a secondary optical laser energy transmitting cladding surrounding the core. In contrast, any surrounding cladding, coatings, or other materials that do not actively transmit the laser energy may not be included in the disclosed ranges.

The embodiments below will describe various instruments and portions of instruments in terms of their state in three-dimensional space. As used herein, the term “position” refers to the location of an object or a portion of an object in a three-dimensional space (e.g., three degrees of translational freedom along Cartesian x-, y-, and z-coordinates). As used herein, the term “orientation” refers to the rotational placement of an object or a portion of an object (three degrees of rotational freedom—e.g., roll, pitch, and yaw). As used herein, the term “pose” refers to the position of an object or a portion of an object in at least one degree of translational freedom and to the orientation of that object or portion of the object in at least one degree of rotational freedom (up to six total degrees of freedom).

According to exemplary embodiments described herein, position and/or orientation may be measured and discussed with respect to a reference frame. In some cases, a reference frame may be an absolute global reference frame which does not change. For example, a local gravitational direction may establish a global reference frame relative to earth. In some cases, a reference frame may be a local reference frame tied to an orientation or position of a component of a system. For example, a local reference frame may be established based on a optics assembly, or on the orientation of a motion stage associated with an optics assembly. In some cases, various reference frames may be registered to one another such that a pose in one reference frame may be understood in the context of another reference frame. Techniques and methods described herein may employ a global reference frame, local reference frame, or a combination thereof.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

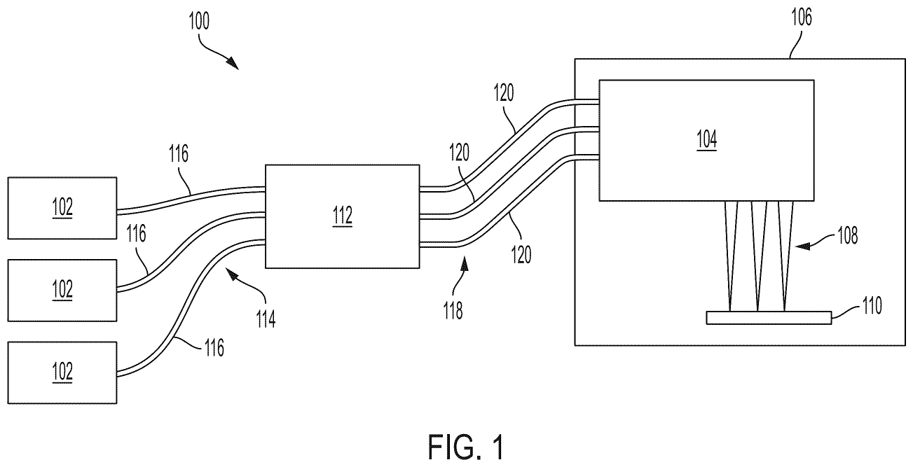

FIG. 1 shows, according to some embodiments, a schematic representation of an additive manufacturing system 100, including a plurality of laser energy sources 102 that deliver laser energy to an optics assembly 104 positioned within a machine enclosure 106. For example, the machine enclosure may define a build volume in which an additive manufacturing process may be carried out. In particular, the optics assembly may direct laser energy 108 towards a build surface 110 positioned within the machine enclosure to selectively fuse powdered material on the build surface. As described in more detail below, the optics assembly 104 may include a plurality of optics defining an optical path within the optics assembly that may transform, shape, and/or direct laser energy within the optics assembly such that the laser energy is directed onto the build surface as an array of laser energy pixels. In some embodiments, the optics assembly may be movable within machine enclosure 106 to scan laser energy 108 across build surface 110 during a manufacturing process. For example, the optics assembly may be associated with appropriate actuators, rails, motors, and/or any other appropriate structure capable of optics assembly relative to the surface. Alternatively, embodiments in which the optics assembly includes galvomirrors or other appropriate components that are configured to scan the laser energy 108 across the build surface while the optics assembly is held stationary relative to the build surface are also contemplated.

In some embodiments, the additive manufacturing system 100 further includes one or more optical fiber connectors 112 positioned between the laser energy sources 102 and the optics assembly 104. As illustrated, a first plurality of optical fibers 114 may extend between the plurality of laser energy sources 102 and the optical fiber connector 112. In particular, each laser energy source 102 may be coupled to the optical fiber connector 112 via a respective optical fiber 116 of the first plurality of optical fibers 114. Similarly, a second plurality of optical fibers 118 extends between the optical fiber connector 112 and the optics assembly 104. Each optical fiber 116 of the first plurality of optical fibers 114 is coupled to a corresponding optical fiber 120 of the second plurality of optical fibers 118 within the optical fiber connector. In this manner, laser energy from each of the laser energy sources 102 is delivered to the optics assembly 104 such that laser energy 108 can be directed onto the build surface 110 during an additive manufacturing process (i.e., a build process). Other methods of connecting the laser energy sources 102 due to the optics assembly 104 are also contemplated.

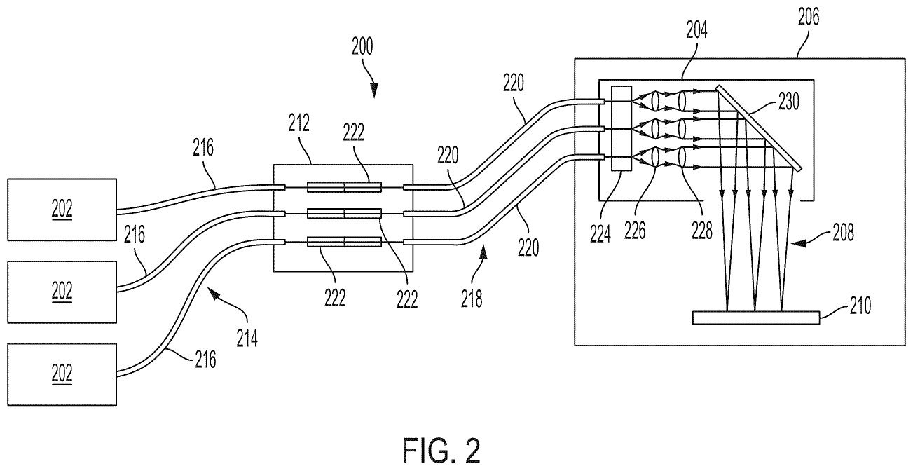

FIG. 2 shows a schematic representation of another embodiment of an additive manufacturing system 200. Similar to the embodiment discussed above in connection with FIG. 1, the additive manufacturing system 200 includes a plurality of laser energy sources 202 coupled to the optics assembly 204 within the machine enclosure 206 via the optical fiber connector 212. The first plurality of optical fibers 214 extends between the laser energy sources 202 and the optical fiber connector 212, and the second plurality of optical fibers 218 extends between the optical fiber connector 212 and optics assembly 204. In particular, each optical fiber 216 of the first plurality of optical fibers is coupled to a laser energy source 202 and corresponding optical fiber 220 of the second plurality of optical fibers 218. In the depicted embodiment, optical fibers 216 are coupled to corresponding optical fibers 220 via fusion splices 222 within the optical fiber connector 212. However, embodiments, in which the optical fibers positioned within the connector are optically coupled using other types of connections and/or single continuous optical fibers are used are also envisioned.

In the depicted embodiment, the optical fibers 220 of the second plurality of optical fibers 218 are optically coupled to an optics assembly 204 of the system. For example, an alignment fixture 224 is configured to define a desired spatial distribution of the optical fibers used to direct laser energy into the optics assembly. For example, the alignment fixture may comprise a block having a plurality of v-grooves or holes in which the optical fibers may be positioned and coupled to in order to accurately position the optical fibers within the system.

FIG. 2 also depicts exemplary optics that are optically coupled to and positioned downstream from the second plurality of optical fibers 218. The various optics included in the optics assembly may be configured to direct laser energy 208 from the second plurality of optical fibers 218 on the build surface 210 to form a desired array pattern of laser energy pixels on the build surface. For example, the optics assembly may include beam forming optics such as lenses 226 and 228 (which may be individual lenses, lens arrays, and/or combined macrolenses), mirrors 230, and/or any other appropriate type of optics disposed along the various optical paths between the optical fibers and the build surface 210 which may shape and direct the laser energy within the optics assembly. Once appropriately sized and shaped, the laser energy 208 may be directed onto the build surface 210 either through direct transmission and/or using a light directing element such as the depicted mirror 230.

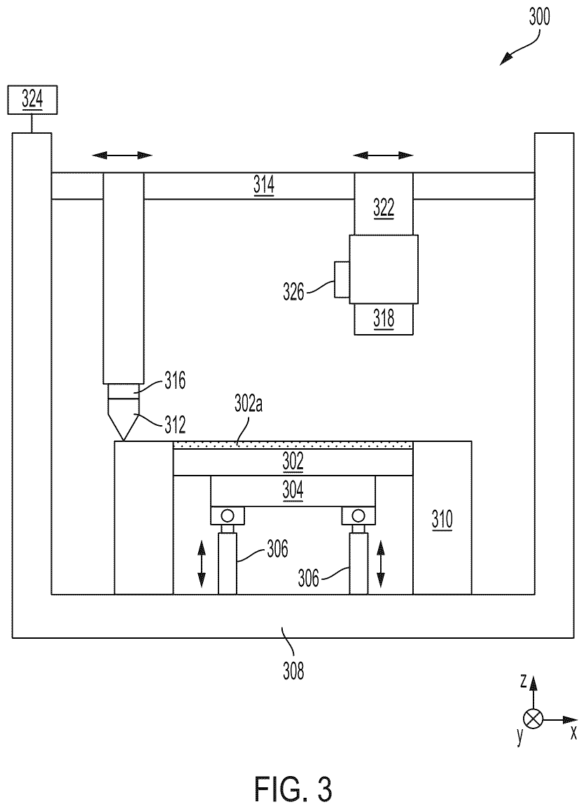

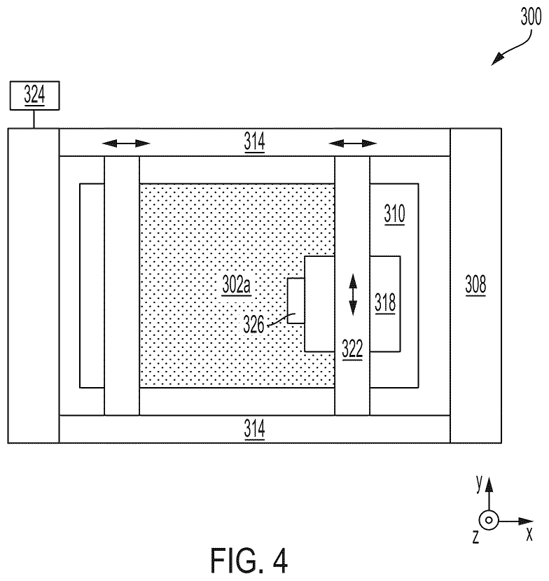

FIGS. 3-4 depict one embodiment of an additive manufacturing system at the beginning of a build process. The additive manufacturing system includes a build plate 302 mounted on a fixed plate 304, which is in turn mounted on one or more build plate actuators 306 that attach to a base 308 of the additive manufacturing system. In the depicted embodiment, the one or more build plate actuators may correspond to one, two, and/or any other appropriate number of actuators or other supports configured to support the build plate, and the corresponding build surface, at a desired position and orientation. For example, the actuators depicted in the figure may correspond to one or more vertical motion stages configured to control a vertical position and orientation of the build plate. In some embodiments, the additive manufacturing system may include three build plate actuators 306 arranged in a triangle. In some such embodiments, the build plate actuators may be configured to move the build plate 302, via the fixed plate 304, in three degrees of freedom. The three degrees of freedom may include rotation about the x-axis (e.g., roll), rotation about the y axis (e.g., pitch), and translation in the vertical direction (e.g., along the z-axis). A powder containment shroud 310 may at least partially, and in some embodiments completely, surround a perimeter of the build plate 302 to support a volume of precursor material layer 302a, such as a volume of powder, disposed on the build plate and contained within the shroud. The shroud may be supported on the base 308 or by any other appropriate portion of the system.

While in the embodiment of FIGS. 3-4 the additive manufacturing system includes three build plate actuators 306 configured as linear actuators, in other embodiments other arrangements of build plate actuators may be employed. In some embodiments, an additive manufacturing system may include one or more vertical actuators and one or more rotational actuators. According to such embodiments, the build plate may have at least one translational degree of freedom (e.g., vertical translation) and at least one rotational degree of freedom (e.g., pitch and/or roll). In some embodiments, an additive manufacturing system may include one vertical actuator and two rotational actuators. As still yet another example, at least one actuator may include two vertical actuators and one rotational actuator. Actuators may include motors, servos, linear actuators, or any other suitable form of actuator, as the present disclosure is not so limited.

The additive manufacturing system may include a powder deposition system in the form of a recoater 312 that is mounted on a horizontal motion stage 314 that allows the recoater to be moved back and forth across either a portion, or entire, surface of the build plate 302. In some embodiments as shown in FIG. 3, the horizontal motion stage 314 may include a rail that allows the recoater 312 to move along the x-axis across the build plate 302 (e.g., a first degree of freedom). As the recoater traversers the build surface of the build plate, it deposits a precursor material layer 302a, such as a powder, onto the build plate and smooths the surface to provide a layer of precursor material with a predetermined thickness on top of the underlying volume of fused and/or unfused precursor material deposited during prior formation steps. The horizontal direction along the x-axis may be approximately parallel to the desired or nominal position of a build surface of the material layer 302a and an upper surface of the build plate 302.

In some embodiments, the build plate actuators 306 of the build plate 302 may be used to index the build surface of the build plate 302 in a vertical downwards direction relative to a local direction of gravity. In such an embodiment, the recoater 312 may be held vertically stationary for dispensing precursor material layer 302a, such as a precursor powder, onto the exposed build surface of the build plate as the recoater is moved across the build plate each time the build plate is indexed downwards.

In some embodiments, the additive manufacturing system may also include an optics assembly 318 that is supported vertically above and oriented towards the build plate 302. As detailed above, the optics assembly may be optically coupled to one or more laser energy sources, not depicted, to direct laser energy in the form or one or more laser energy pixels onto the build surface of the build plate 302. To facilitate movement of the laser energy pixels across the build surface, the optics assembly may be configured to move in one, two, or any number of directions in a plane parallel to the build surface of the build plate (e.g., in the x-y plane). To provide this functionality, the optics assembly may be operatively coupled to the horizontal motion stage 314. According to some such embodiments, as the recoater 312 and the optics assembly 318 share the same horizontal motion stage, the recoater movement may be inherently registered to the reference frame of the optics assembly such that the recoater and the optics assembly move in directions along the horizontal motion stage that are substantially parallel to one another. The optics assembly 318 may include a second horizontal motion stage 322 operatively coupled to the horizontal motion stage 314 to provide movement in the y-direction perpendicular to the x direction (e.g., a second degree of freedom perpendicular to the first degree of freedom). In other embodiments, the optics assembly 318 may be operatively coupled to another actuated structure such as a gantry, that allows the optics unit to be scanned in plane parallel to the build surface of the build plate. In some embodiments, such a gantry may be separate from a motion stage of the recoater 312.

In the above embodiment, the build plate is indexed vertically while the remaining active portions of the system are held vertically stationary. However, embodiments, in which the build plate is held vertically stationary and the shroud 310, recoater 312, and optics assembly 318 are indexed vertically upwards relative to a local direction of gravity during formation of successive layers are also contemplated. In such an embodiment, the recoater horizontal motion stage 314 may be supported by vertical motion stages 316 that are configured to provide vertical movement of the recoater relative to the build plate. Corresponding vertical motion stages may also be provided for the shroud 310, not depicted, to index the shroud vertically upward relative to the build plate in such an embodiment. In some embodiments, the additive manufacturing system may also include an optics assembly 318 that is supported on a vertical motion stage that allows the optics unit to be moved in the z-direction.

In the above embodiment, the vertical motion stages and horizontal motion stages may correspond to any appropriate type of system that is configured to provide the desired vertical and/or horizontal motion. That is, while rails are depicted in the embodiment of FIGS. 3-4, in other embodiments any suitable support structure may be employed. This may include supporting structures such as: gantries, rails, linear bearings, wheels, threaded shafts, rods, channels, and/or any other appropriate structure capable of supporting the various components during the desired movement. Motion stages may include various types of actuators such as linear motors, stepper motors, motor and transmission combinations, belt driven systems, and/or any other appropriate type of actuator capable of driving the associated motion stage. Any other appropriate type of actuator may also be employed, as the disclosure is not so limited.

According to some embodiments as shown in FIGS. 3-4, the additive manufacturing system 300 may include one or more distance sensors 326. In the depicted embodiment, the one or more distance sensors are coupled to the optics assembly 318 and are accordingly configured to move with the optics assembly in the x-y plane (e.g., first and second degrees of freedom). In some embodiments, the one or more distance sensors 326 are a single point distance sensor configured to measure a distance from the optics assembly 318 to the build plate 302, shroud 310, and/or the precursor material layer 302a. The measured distances may be in the z-direction, perpendicular to the x-y plane. A plurality of distance measurements may be collected by the one or more distance sensors 326 as the optics assembly 318 moves in the first degree of freedom (e.g., the x-axis) and/or the second degree of freedom (e.g., the y-axis). Accordingly, the one or more distance sensors 326 may obtain a plurality distance measurements to create a three-dimensional point cloud representative of components of the additive manufacturing system. For example, for planar components such as a build surface or build plate, the point cloud may be representative of a plane or line in the reference frame of the additive manufacturing system. As discussed further below, such measurements may be employed to determine the pose of the build plate 302, shroud 310, and/or the precursor material layer 302a in three-dimensional space with respect to a reference frame of the optics assembly 318. In some other embodiments, the one or more distance sensors may include a plurality of distance sensors. In some embodiments, the one or more distance sensors may be positioned at fixed locations with respect to the base 308 and may not move. In some embodiments, the one or more distance sensors may include a LiDAR sensor. Any suitable distance sensors may be employed in any number in other embodiments, as the present disclosure is not so limited.

In addition to the above, in some embodiments, the depicted additive manufacturing system may include one or more controllers 324 having at least one processor that is operatively coupled to the various actively controlled components of the additive manufacturing system. For example, the one or more controllers may be operatively coupled to the one or more build plate actuators 306, recoater 312, optics assembly 318, the various motion stages, and/or any other appropriate component of the system. In some embodiments, the controller may include at least one processor and associated non-transitory computer readable memory. The non-transitory computer readable memory may include processor executable instructions that when executed by the one or more processors cause the additive manufacturing system to perform any of the methods disclosed herein.

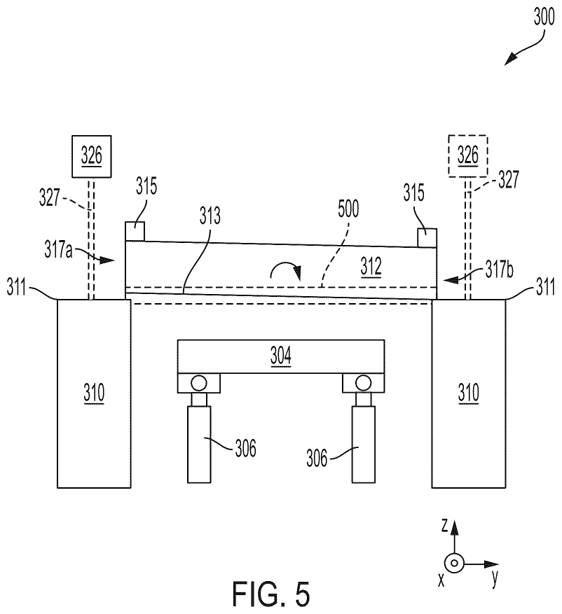

FIG. 5 shows a front view schematic of an additive manufacturing system 300 according to some embodiments during a recoater blade adjustment process. As shown in FIG. 5, the additive manufacturing system 300 is like that described with reference to FIGS. 3-4, and includes a fixed plate 304 supported by one or more build plate actuators 306. In the state shown in FIG. 5, no build plate is installed. As shown in FIG. 5, the shroud 310 includes a deck 311 disposed on either side of the fixed plate 304. The additive manufacturing system 300 includes a recoater 312 arranged as a recoater blade in the depicted embodiment. The recoater 312 includes a lower edge 313 and two supports 315. One of the supports is disposed at a first end portion 317a of the recoater 312 and the other the supports is disposed at a second end portion 317b of the recoater. The recoater extends in the y-direction, and is configured to move across a build plate in the x-direction (e.g., a first degree of freedom).

The inventors have appreciated that the orientation of the recoater 312 with respect to the x-axis may affect the quality of a product produced by the additive manufacturing system 300. Specifically, the inventors have appreciated that the orientation of the recoater may affect the thickness of a layer of precursor material deposited on a build plate. For example, as shown in FIG. 5, if the recoater 312 is not parallel to the build plate with respect to the x axis, the layer of material will be thicker on one end and thinner on the other end. As shown in the state of FIG. 5, the layer of material may be thicker adjacent the first end portion 317a and thinner adjacent the second end portion 317b. These differences in thickness may cause differences in melting of the material, affecting the quality of the final product. In some instances, the differences in thickness may cause a build surface to fall outside of the focus volume 500 (e.g., a target three-dimensional volume) of an associated optics assembly (see FIGS. 3-4). Accordingly, the additive manufacturing system 300 of FIG. 5 may be configured to provide feedback to a user to allow the recoater 312 to be adjusted so that the lower edge 313 is disposed within the focus volume 500. Specifically, the additive manufacturing system 300 may provide feedback regarding height adjustments using the supports 315 to appropriately orient the recoater 312 with respect to the x-axis for a reference frame of the additive manufacturing system 300. In some embodiments, independently adjusting the height in the z-direction of the first end portion 317a and the second end portion 317b may rotate the recoater about the x-axis.

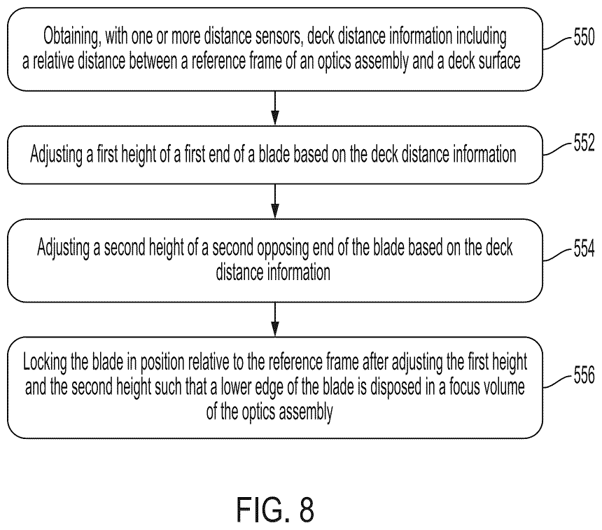

In some embodiments as shown in FIG. 5, the additive manufacturing system 300 includes one or more distance sensors 326 configured to measure distances along the z-axis with respect to a reference frame of the optics assembly (e.g., a reference frame of the additive manufacturing system). In some embodiments, the one or more distance sensors 326 may be coupled to an optics assembly and may be configured to move in a two-dimensional plane (e.g., along the x and y axes) and measure a plurality of distances. For blade installation and/or adjustment, the one or more distance sensors 326 may be configured to collect a plurality of distance measurements of the deck 311 of the shroud 310. The plurality of distance measurements may be fit to a deck plane by at least one process of the additive manufacturing system 300, such that the pose of the deck 311 may be registered with respect to the reference frame of the optics assembly. The one or more distance sensors may be configured to emit a laser 327 and measure a phase shift or time of flight of the laser to determine a distance along the z-axis. In some embodiments, the one or more distance sensors 326 may be employed to measure multiple portions of the deck 311, for example adjacent to the first end portion 317a and the second end portion 317b. As discussed further below with reference to FIGS. 7-8, the distance information of the deck 311 may be employed to determine height adjustments for the recoater to place a lower edge 313 of the recoater in a target three-dimensional focus volume 500.

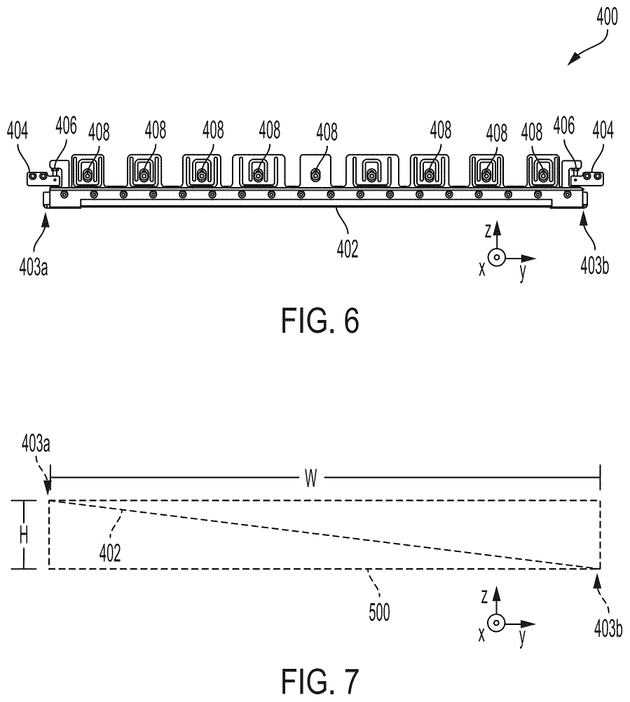

FIG. 6 shows a recoater blade 400 of an additive manufacturing system according to some embodiments. As shown in FIG. 6, the recoater blade 400 includes a lower edge 402. The lower edge 402 extends along the y-axis, and the recoater is configured to move along the x-axis. The lower edge includes a first end portion 403a and a second end portion 403b. The recoater blade includes supports 404 configured to allow the height of the first end portion 403a and the second end portion 403b to be adjusted. In the example of FIG. 6, the supports 404 include screws 406 configured to allow the relative spacing between the first and second end portions and their respective supports to be adjusted. In other embodiments any suitable arrangement for height adjustment may be employed as the present disclosure is not so limited. The recoater blade 400 also includes a plurality of mounting bolts 408. The mounting bolts may be tightened to secure the position of the recoater blade with respect to the additive manufacturing system. Accordingly, after the heights of the of the first end portion 403a and the second end portion 403b are adjusted, the mounting bolts 408 may be used to secure the recoater blade 400 in the desired pose.

FIG. 7 shows an example of a focus volume 500 and pose of a lower blade edge 402 according to some embodiments. The focus volume 500 may be a rectangular prism. In the view aligned with the x-axis shown in FIG. 7, the focus volume accordingly appears as a rectangle. The focus volume may represent a volume in which laser energy from an optics assembly is focused and may represent a range in which appropriate melting of a build surface will occur. The focus volume may have a height H and width W. The width may be determined based on a range of motion of an optics assembly along the x-axis. The height may be determined based on an optical arrangement of the optics assembly. In some embodiments, the height may be approximately 1 mm (e.g., plus or minus 500 micron from a nominal focal plane). Accordingly, it is desirable that a build surface and an entire thickness of a layer of precursor material is disposed in the focus volume for appropriate additive manufacturing. The inventors have appreciated that adjusting a first end portion 403a and a second end portion 403b of a lower blade edge 402 may ensure that a build surface is disposed in the focus volume 500. For example, the position of the first end portion 403a and the second end portion 403b may be adjusted with respect to the z-axis to rotate the blade edge 402 about the x-axis so that the blade edge is located fully within the focus volume.

FIG. 8 shows a block diagram for a method of operating an additive manufacturing system according to some embodiments. In block 550, deck distance information is obtained with one or more distance sensors, where the deck distance information includes a relative distance between a reference frame of an optics assembly and a deck surface. The deck may be an uppermost surface of a shroud or other powder containment structure, in some embodiments, and may be disposed adjacent a build plate in a horizontal direction. In some embodiments, obtaining deck distance information may include collecting a plurality of distance measurements as the one or more distance sensor move in a first degree of freedom (e.g., x direction) and/or a second degree of freedom (e.g., y direction). In some embodiments, the method may include fitting the deck distance information to a plane to obtain a deck plane representative of the pose of the deck surface in three-dimensional space with respect to the reference frame of the optics assembly. In block 552, a first height of a first end of a recoater blade is adjusted based on the deck distance information. In some embodiments, the height adjustment may include rotating a screw. In some embodiments, the height adjustment may include using an appropriately sized shim to lift the recoater blade. In some embodiments, the method may include providing to a user a first height adjustment based on the deck distance information. In block 554, a second height of a second end of a recoater blade is adjusted based on the deck distance information. In some embodiments, the second height adjustment may include rotating a screw. In some embodiments, the second height adjustment may include using an appropriately sized shim to lift the recoater blade. In some embodiments, the method may include providing to a user a second height adjustment based on the deck distance information. Adjusting the first height and the second height may rotate and orient the recoater blade with respect to an axis perpendicular to a length of the recoater blade. In block 556, the recoater blade is locked in position relative to the reference frame of the optics assembly after adjusting the first height and the second height. In some embodiments as shown in FIG. 8, the height adjustments may ensure a lower edge of the recoater blade is disposed in a focus volume of the optics assembly. According to some embodiments, the steps of blocks 552-556 may be partially or fully automated, for example, with one or more actuators. In some such embodiments, a recoater blade may include one or more actuators configured to adjust the vertical height and/or orientation of the recoater blade.

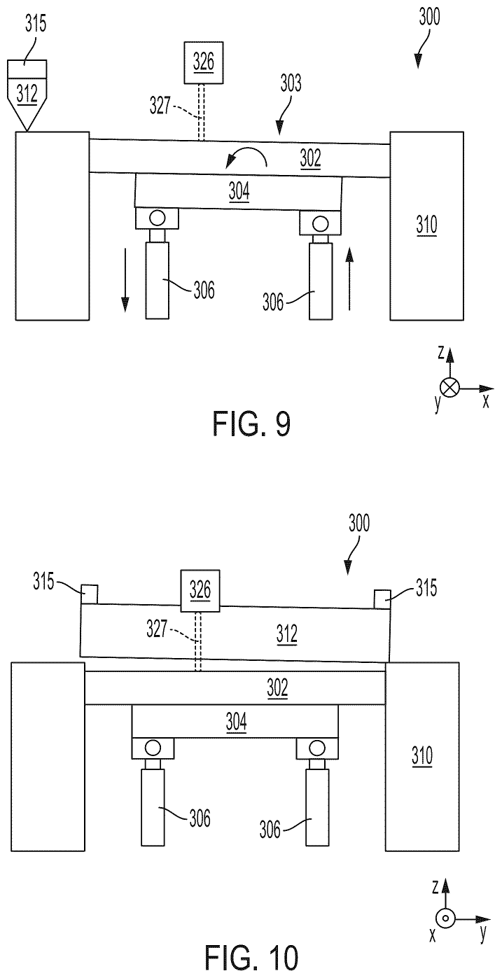

FIGS. 9-10 show schematics of an additive manufacturing system 300 according to some embodiments during a build plate adjustment process. As shown in FIGS. 9-10, the additive manufacturing system 300 is similar to that described with reference to FIGS. 3-4. The additive manufacturing system 300 includes a build plate 302 supported by a fixed plate 304. The fixed plate in turn is coupled to build plate actuators 306 that are configured to allow the additive manufacturing system 300 to adjust a pose of the build plate 302. In some embodiments, the actuators 306 may include three linear actuators configured to provide a vertical translation degree of freedom, a first rotational degree of freedom (e.g., pitch about the x-axis), and a second rotational degree of freedom (e.g., roll about the y-axis). The build plate 302 may be configured to be exchanged for each product additively built using the additive manufacturing system 300. The different build plates may have minor variations in dimensions and/or mounting hardware that changes the pose of a build plate plane 303 with reference to a reference frame of an optics assembly (for example, see FIGS. 3-4). The build plate plane 303 may be a plane aligned with an uppermost surface of the build plate facing the optics assembly which is configured to receive a layer of precursor material. As shown in FIGS. 9-10, a shroud 310 surrounds the build plate and is configured to contain the layer of precursor material. As shown in FIGS. 9-10, the additive manufacturing system 300 also includes a recoater 312 including supports 315 configured to allow the height and orientation of the recoater to be adjusted, as discussed above with reference to FIG. 8.

As discussed with reference to prior embodiments, the additive manufacturing system 300 also includes one or more distance sensors 326. The distance sensor depicted in FIGS. 9-10 is a single point distance sensor configured to emit a laser 327 and measure a time of flight or phase shift of reflecting light. In other embodiments, any suitable distance sensor(s) may be employed, as the present disclosure is not so limited. In the embodiment of FIGS. 9-10, the one or more distance sensors 326 may be configured to move in a first degree of freedom (e.g., the x direction) and a second degree of freedom (e.g., the y direction. The distance measured by the one or more distance sensors may be in a vertical direction (e.g., the x direction), which is perpendicular to the first degree of freedom and the second degree of freedom. In this manner, the one or more distance sensors 326 may collect distance information for a plurality of positions within a two-dimensional plane, with the measured distance being representative of a position in the third dimension with respect to a reference frame of the additive manufacturing system 300 (e.g., a reference frame of an optics assembly).

The information from the one or more distance sensors may be employed to register a position of the build plate plane 303 with respect to another reference frame of the additive manufacturing system 300. Based on the distance information to the build plate 302 (e.g., build plate distance information), the actuators 306 may be commanded and controlled to automatically move the build plate 302 to adjust a pose of the build plate. As will be discussed further below, in some embodiments the build plate 302 may be moved so that the build plate plane 303 is disposed in a target three-dimensional volume (e.g., focus volume). Such a movement may ensure a layer of material disposed on the build plate and extending upward from the build plate plane 303 is also disposed within the target three-dimensional volume. Additionally, in some embodiments the build plate 302 may be moved so that the build plate plane is approximately parallel or exactly parallel to the translational degree of freedom of the recoater 312 (e.g., the x-axis), so that a uniform layer of material may be deposited and smoothed on the build plate 302 (and subsequent layers of melted material). According to some such embodiments, “approximately parallel” may refer to an angular tolerance of within 0.06 mrad. In some embodiments, the build plate 302 may be moved so that the build plate plane is within 0.06 mrad of parallel to the translational degree of freedom of the recoater 312. As shown in FIG. 9, the actuators may rotate the build plate 302 about a first rotational degree of freedom (e.g., the x-axis) to align the build plate plane with the x-axis so that as the recoater 312 moves across the build plate, the layer of material is uniform with respect to the x-axis. As shown in FIG. 10, the build plate may also be adjusted with respect to a second rotational degree of freedom (e.g., the y-axis) to level the build plate with respect to the y-axis. Accordingly, in some embodiments the actuator 306 may be command to level the build plate 302 with respect to two Cartesian directions of the reference frame of the additive manufacturing system 300 (e.g., an optics assembly reference frame). As a result, a normal vector from the build plate plane 303 may extend parallel to a local vertical direction (e.g., the z-axis). In some instances, the build plate 302 may be level with respect to the y-axis of the reference frame of the additive manufacturing system 300, but may not be parallel to the recoater. Adjusting the build plate further to ensure a uniform thickness of material with respect to the y-axis is discussed further with reference to the example of FIGS. 13-14.

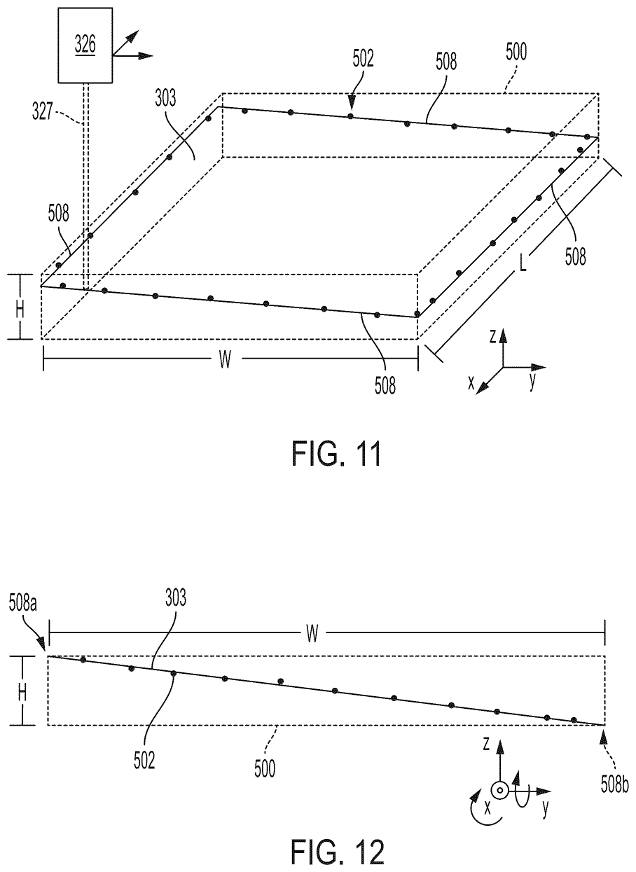

FIG. 11 shows a perspective example of a focus volume 500 and pose of a build plate plane 303 and blade of an additive manufacturing system according to some embodiments. The schematic of FIG. 11 may correspond to the system shown in FIGS. 9-10, in some embodiments. As shown in FIG. 11, a distance sensor 326 is configured to emit a laser 327 (e.g., an infrared laser) to measure a relative distance between the distance sensor and the build plate plane 303 using time of flight or phase shift. The distance sensor 326 may collect a plurality of distance measurements 502 in a first degree of freedom (e.g., along the x-axis) and a second degree of freedom perpendicular to the first degree of freedom (e.g., the y-axis). In some embodiments, the distance sensor 326 may be configured to move along edges 508 of the build plate plane. In other embodiments, the distance sensor may move in an “X” pattern across the build plate plane, though any pattern for characterizing a pose of the build plate plane may be used as the disclosure is not so limited. In still other embodiments, other patterns may be employed to collect distance information within a two-dimensional plane. In some embodiments, at least three distance measurements at different locations may be obtained by the distance sensor 326. Each of the distance measurements 502 may correspond to a three-dimensional point in space. The position of the distance sensor 326 in the first degree of freedom (e.g., x-axis) and the second degree of freedom (e.g., y-axis) may determine the (x, y) position of the distance measurement. The distance measured may be representative of a relative distance of the build plate plane 303 to a reference frame of an additive manufacturing system so that each measurement corresponds to a location along the vertical axis (e.g., the z-axis). Accordingly, each measurement 502 may have coordinates (x, y, z) with respect to the reference frame of the additive manufacturing system (e.g., a reference frame of an optics assembly of the additive manufacturing system).

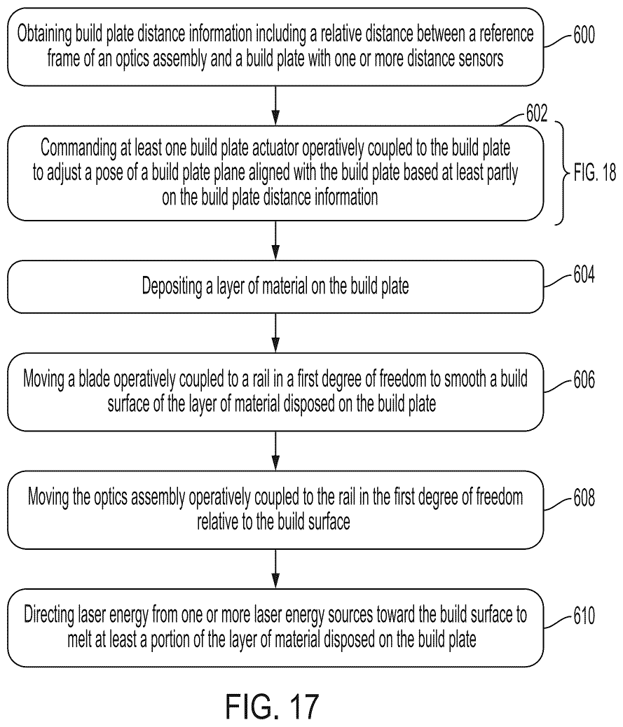

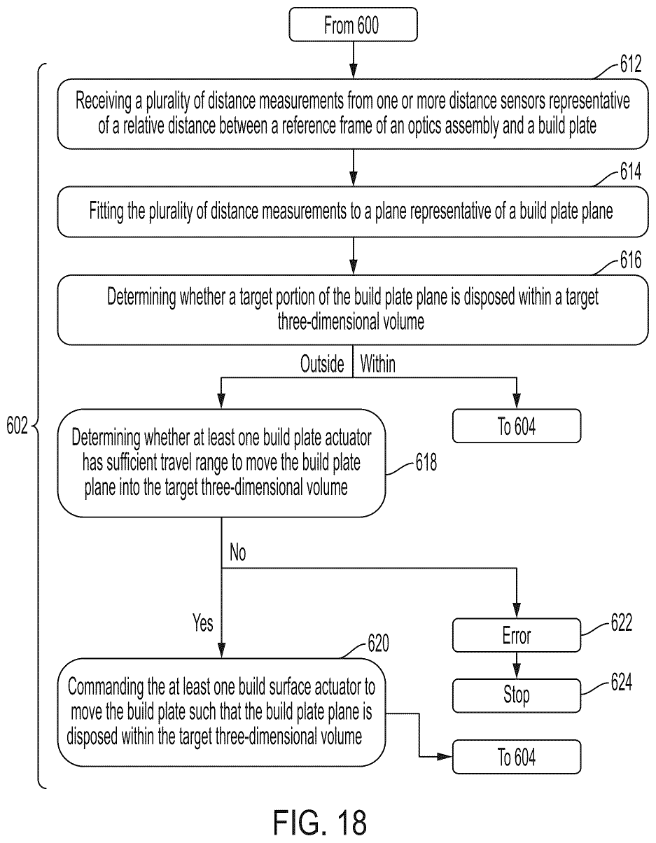

According to the embodiment of FIG. 11, the plurality of distance measurements 502 may be fit to a plane representative of the build plate plane 303. The build plate plane may be a best fit based on the plurality of distance measurements. At least three distance measurements may be employed to obtain the best fit plane, through additional measurements may be employed. In some embodiments, collection of additional points in a pattern may improve accuracy of the fit plane. In some embodiments, based on the fit plane, geometric locations of the build plate plane 303 may be determined. For example, the location of the four edges 508 of the build plate plane 303 corresponding to the four edges of the build plate may be estimated based on known dimensions of the build plate. Appropriate fitting methods are described previously above. In some embodiments, an edge 508 may be determined based on a stepwise change in measured distance greater than a threshold distance. Such a discontinuity in measured distances may be representative of the edge of the build plate. Once the build plate plane 303 is fit to the distance measurements, the location of the build plate plane may be registered to the reference frame of the additive manufacturing system (e.g., a reference frame of an optics assembly). Accordingly, as discussed further below with reference to FIGS. 17-18, the fit plane may be employed to determine movement of the build plate to position and orient the build plate in a desired manner for an additive manufacturing process.

In some embodiments as shown in FIG. 11, the focus volume 500 may be formed as a rectangular prism having a height H, width W, and length L. In the depicted reference frame, the height may correspond to a local vertical direction (e.g., the z-axis). The length L may correspond to a first local horizontal degree of freedom (e.g., x-axis). The width W may correspond to a second local horizontal degree of freedom (e.g., y-axis) that is perpendicular to the first local horizontal degree of freedom. The width and length of the focus volume 500 may be determined based on the size of the build plate. That is, for a larger build plate the length and/or width may increase and for a smaller build plate the length and/or width may decrease. The height H may correspond to a direction that is perpendicular to the length L and width W. The entirety of the length and width of the focus volume may be traversed by a recoater (for example, see FIG. 13). Additionally, the entirely of the length and width may be targetable by an optics assembly so that a material disposed within the focus volume may be melted as a part of an additive manufacturing process. The height of the focus volume 500 may be determined based on the location of a focal plane of the optics assembly where light energy is focused and employed to melt a material. The focal plane may be a horizontal plane with respect to a reference frame of the optics assembly. In the depicted embodiment, the focal plane may be an x-y plane. The optics assembly may have a tolerance on either side of the focal plane where the light energy is still focused enough to provide appropriate melting of a precursor material. In some embodiments, the height may be twice this tolerance from the focal plane. In some embodiments, the height may be approximately 1 mm (e.g., +/−500 micron from the focal plane). In some embodiments, the height may be between 500 and 1250 microns. The inventors have appreciated that such a height provides desirable product quality while providing sufficient range for positioning a build surface within the focus volume, according to methods discussed further below. In some embodiments other ranges of a height of a focus volume may be employed, as the present disclosure is not so limited. As discussed further below, the focus volume 500 may be a target three-dimensional volume, in which the inventors have appreciated that it is desirable to position (1) a build plate plane (or underlying material plane); and (2) a build surface plane (see FIGS. 13-14). By positioning both of these planes within the focus volume 500, an entire thickness of a material layer may be positioned in the focus volume, improving the quality and reliability of products produce by the additive manufacturing system.

FIG. 12 shows a side view of the focus volume 500 and pose of a build plate plane 303 of FIG. 11, with the view aligned on the x-axis. As shown in FIG. 11, the plurality of distance measurements 502 may have some variability in accordance with a precision of the distance sensor. The best fit plate may therefore have enhanced accuracy with the presence of additional distance measurements. In some embodiments only three distance measurements may be employed to reduce the time to adjust a pose of a built plate, as the present disclosure is not so limited. As shown in FIG. 12, a first edge 508a and a second opposing edge 508b may both be disposed within the focus volume 500. However, as noted above, it is desirable that both a build plate plane and a build surface plane are disposed within the focus volume 500 so that an entire thickness of a layer of a precursor material to be melted is also disposed in the focus volume. As shown in FIG. 12, the first edge 508a is at the top of the focus volume, such that any added material layer would be disposed outside of the focus volume. Such a circumstance may be undesirable. Accordingly, as will be discussed with reference to FIGS. 17-18, an additive manufacturing system may determine and execute movements and/or rotations (e.g., about the x-axis and the y-axis) of the build plate to ensure the thickness of the material layer is disposed within the focus volume 500.

FIG. 13 shows a perspective example of a focus volume 500 and material layer 302a on a build plate after smoothing by a recoater blade according to some embodiments. As shown in FIG. 13, the build plate is represented by build plate plane 303. The material layer 302a extends upward in the z-direction from the build plate plane 303. A recoater including the recoater blade 400 may move in a first degree of freedom (e.g., along the x-axis) to deposit the material layer on the build plate plane 303 and to smooth a build surface 504 of the material layer. The build surface 504 is an uppermost surface of the material layer facing an optics assembly.

As shown in FIG. 13, the system includes a distance sensor 326 configured to obtain distance information as described with reference to FIG. 11. The state shown in FIG. 13 may be a state following an initial registration of the build plate plane 303 to a reference frame of an additive manufacturing system (e.g., a reference frame of the optics assembly) discussed with reference to FIGS. 11-12. As the material layer 302a covers the build plate, the distance sensor 326 may no longer be able to measure a distance to the build plate. Rather, the distance sensor 326 may measure distances to the build surface 504 of the material layer. The distance sensor is configured to collect a plurality of distance measurements 510 to the build surface to obtain build surface distance information. The build surface distance information may be employed to further move the build plate to ensure a uniform thickness of material that is also fully disposed within the focus volume 500. The build surface distance information may be employed to fit a line or a plane to determine a pose of the build surface with respect to the reference frame of the additive manufacturing system.

In some embodiments, a recoater blade 400 may share a motion stage with an optics assembly. For example, the recoater blade 400 and the optics assembly may share the same rail. While the recoater blade 400 and the optics assembly may share a motion stage and a degree of freedom, there may be misalignment between the build plate and the recoater blade 400 due to the orientation of the recoater blade. Accordingly, a build surface formed by the recoater blade may have a different plane compared to the build plate plane. As a result of the misalignment, the material layer may have a non-uniform thickness along a degree of freedom perpendicular to the degree of freedom of the recoater blade (e.g., the y-axis). With respect to movement in the first degree of freedom (e.g., the x-axis), registration and leveling of the build plate about the second degree of freedom (e.g., pitch about the y-axis) may ensure that the build plate is also level with respect to the degree of freedom of the recoater blade 400. Additionally, the registration and leveling of the build plate about the first degree of freedom (e.g., roll about the x-axis) may ensure that the recoater blade and build plate are aligned and a material layer of uniform thickness is formed when the recoater blade moves across the build plate in the first degree of freedom.

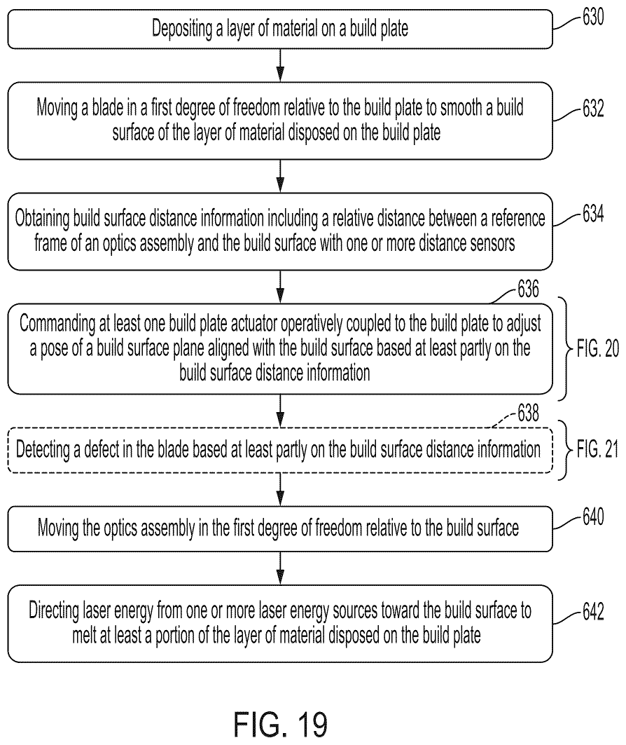

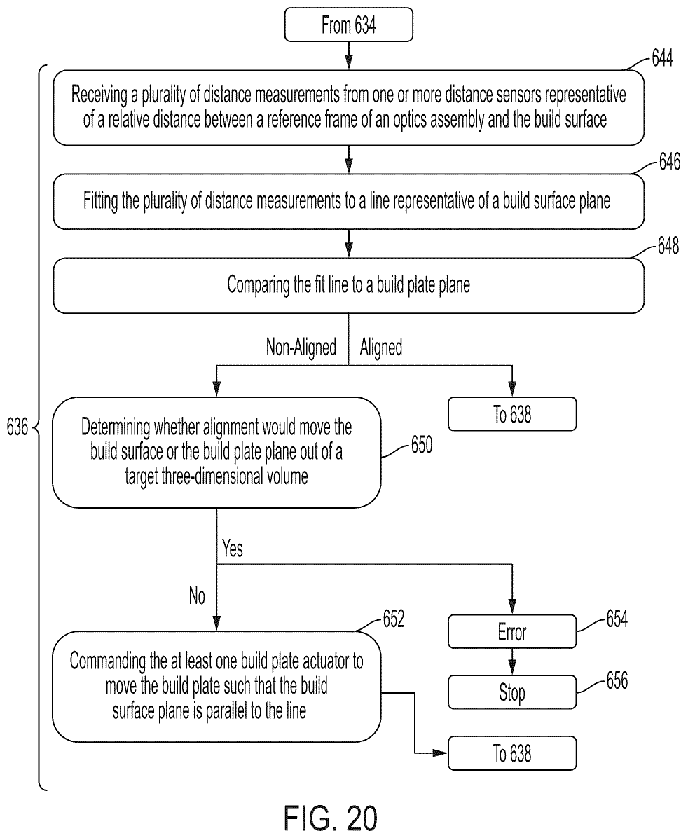

The recoater blade supports 404 provide adjustment in orientation about the first degree of freedom (e.g., roll about the x-axis). However, the smoothed profile of the build surface 504 along the x axis may be constant if the build plate is level with respect to the shared motion stage. In such embodiments, the distance sensor 326 may make the plurality of distance measurements 510 in a line 512 parallel to the second degree of freedom. The line 512 may also be parallel to the recoater blade 400. This is because it can be assumed that the build plate is level with respect to rotation about the y-axis so differences in orientation between the build plate and the recoater blade 400 may exist for rotation about the x-axis (e.g., roll) only in some embodiments. As the plurality of distance measurements 510 may extend in a line, a line may be fit to the measurements rather than a plane (for example, see FIG. 14). Such an arrangement may reduce the number of distance measurements collected by the distance sensor 326, and may otherwise simplify a build plate adjustment process. In other embodiments distance measurements may be obtained in two degrees of freedom similar to FIG. 11 and a plane may be fit to determine the pose of the build surface 504 plane, as the present disclosure is not so limited. The build surface distance information may be employed to further move a build plate to achieve a uniform thickness of material disposed entirely within the focus volume, as will be discussed further with reference to FIGS. 19-20.

FIG. 14 shows a side view of the focus volume 500 and material layer 302a of FIG. 13. As shown in FIG. 14, the material layer has a first end 514a and a second end 514b. The thickness of the material layer at the first end 514a is greater than the thickness of the material layer at the second end 514b. Accordingly along the second degree of freedom (e.g., the y-direction), the material layer does not have a uniform thickness. As shown in FIG. 14, a build plate plane 303 is horizontal and level. However, a recoater blade may be non-level with respect to the underlying build plate, such that the build surface 504 is at an angle with respect to the build plate plane 303. As shown in FIG. 14, a plurality of distance measurements 510 were collected along a line parallel to the second degree of freedom. A line 516 may be fit to the plurality of distance measurements 510 (shown offset from the build surface 504 for clarity). The fit line may be representative of an incline of a build surface plane about the first degree of freedom (e.g., roll about the x-axis). Accordingly, the line 516 may be employed to register the position of the build surface 504 with respect to a reference frame of the additive manufacturing system (e.g., an optics assembly reference frame). As noted previously, in other embodiments a plane may be fit instead of a line where the optics assembly and recoater do not share a motion stage. Based on the registered pose of the build plate plane 303 and the registered pose of the line 516, the build plate plane may be adjusted to be parallel to the build surface if the entire thickness of the material layer 302a is still disposed in the focus volume 500. Such a method is discussed further with reference to FIGS. 19-20. It should be noted that in some embodiments herein the build plate may be moved with one or more automated actuators, whereas the recoater blade is installed manually and is not adjustable in an automated manner. In some embodiments methods described herein with respect to build plate adjustment may be applicable to actuators associated with a recoater blade, as the present disclosure is not so limited. For example, one or more actuators may move a recoater blade to make the recoater blade parallel to the registered build plate plane 303, in some embodiments.

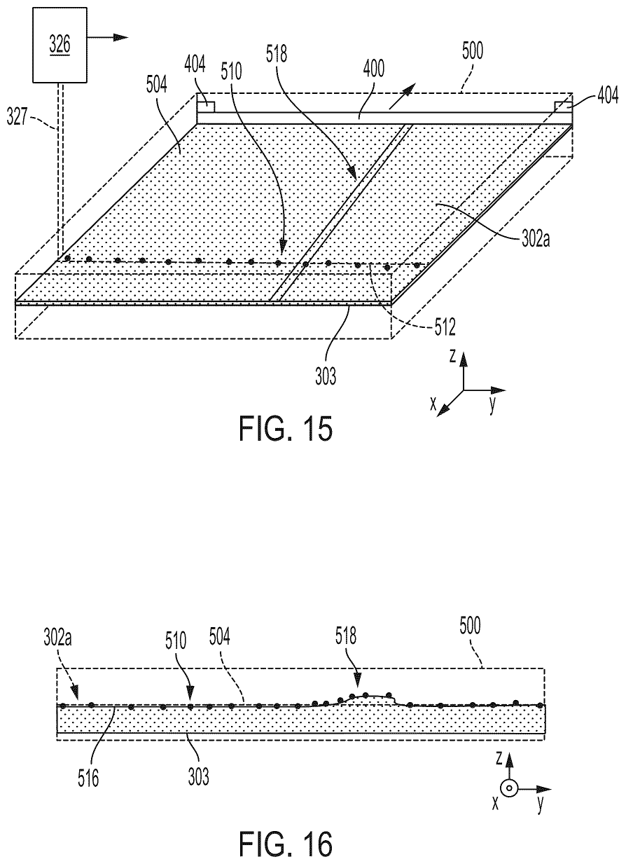

FIG. 15 shows a perspective example of a focus volume 500 and material layer 302a on a build plate after smoothing by a recoater blade 400 according to some embodiments and FIG. 16 shows a side view of the focus volume and material layer of FIG. 15. As shown in FIG. 15, the state is similar to that shown in FIG. 13. That is, a material layer 302a is disposed on top of a build plate (represented by build plate plane 303) and is smoothed by blade 400 moving in a first degree of freedom (e.g., the x-axis). A distance sensor 326 obtains build surface distance information by collecting a plurality of distance measurements 510 along a line 512 parallel to a second degree of freedom (e.g., the y-axis) and the recoater blade 400. The inventors have appreciated that the distances measured along the line 512 indirectly correspond to a profile of a lower edge of the recoater blade 400. That is, the build surface 504 effectively represents the profile of the lower blade edge. Accordingly, the inventors further appreciated that defects in a recoater blade may be automatically detected as a part of a build plate adjustment process.

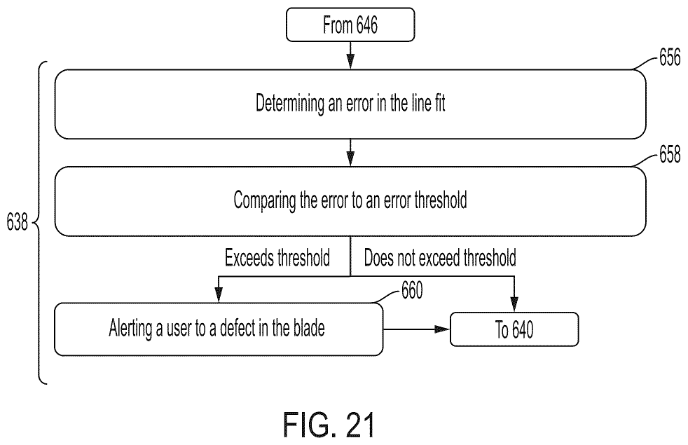

In the example of FIGS. 15-16, the build surface 504 of the material layer 302a includes a protrusion 518. The protrusion is an increased thickness of the material layer in a localized area, and accordingly results in a layer having a non-uniform thickness. The protrusion 518 may be caused by damage to the recoater blade 400. For example, a nick, dent, or other physical damage may cause the recoater blade to no longer be straight. The inventors have appreciated that the fitting process described herein may be employed to automatically detect such defects to avoid using a recoater blade with undesirable straightness for an additive manufacturing process. For example, as shown in FIG. 16, a line 516 may be fit to the plurality of distance measurements 510. The best fit line may have an error associated with the line fit. The error of the line fit may be compared to an error threshold. If the error threshold is exceeded, a defect may be detected, and the additive manufacturing system may alert a user to change the recoater blade 400. Other methods may be implemented, in some embodiments. For example, the distances between adjacent points may be compared, and if a difference in height exceeds a predetermined threshold a defect may be detected. An exemplary method of blade defect detection is discussed further with reference to FIG. 21.

FIG. 17 shows a block diagram for a method of operating an additive manufacturing system according to some embodiments. In block 600, build surface distance information is obtained by one or more distance sensors (for example, see FIG. 11). The build surface distance information may be representative of a relative distance between a reference frame of an optics assembly or other reference frame of the additive manufacturing system and a build plate. In block 602, at least one build plate actuator is commanded to adjust a pose of a build plate plane based on the build plate distance information. An example of block 602 is discussed in detail with reference to FIG. 18. As a result of block 602, the build plate plane may be positioned within a focus volume of the optics assembly. In block 604, a layer of material is deposited on the build plate. In block 606, a recoater blade operatively coupled to a horizontal motion stage (e.g., a rail) is moved in a first degree of freedom to smooth a build surface of the layer of material disposed on the build plate. In some embodiments the recoater blade may fully traverse the build plate. In block 608, the optics assembly may be moved in the first degree of freedom relative to the build surface. In some embodiments, the optics assembly may also move in a second degree of freedom perpendicular to the first degree of freedom. In some embodiments as shown in FIG. 17, the optics assembly and the recoater blade may be operatively coupled to the same horizontal motion stage (e.g., a rail). In block 610, laser energy is directed from one or more laser energy sources toward the build surface to melt at least a portion of the layer of material disposed on the build plate.

FIG. 18 shows a further block diagram for the method of operating an additive manufacturing system according to FIG. 17. Specifically, FIG. 18 shows exemplary steps associated with block 602 in FIG. 17. As shown in FIG. 18, the method may include, in block 612, receiving a plurality of distance measurements from one or more distance sensors representative of a relative distance between the reference frame of the optics assembly and a build plate. In block 614, the plurality of distance measurements may be fit to a plane representative of a build plate plane. The plurality of distance measurements may include at least three points which may be best fit to a two-dimensional plane. The fitting of the plane may register the build plate plane to the reference frame of the additive manufacturing system.

In block 616, it is determined if the build plate plane is disposed within a target three-dimensional volume. The target three-dimensional volume may be a focus volume as discussed herein. If a target portion of the build plate plane is disposed within the target three-dimensional volume, block 602 may end and the method may continue with block 604 in FIG. 17. Optionally, instead of immediately proceeding to block 604, the method may include determining if the build plate can be moved to be leveled with respect to the registered reference frame without moving the build plate plane outside of the target three-dimensional volume. If the build plate plane can be moved to adjust the pose so that the build plate is level with respect to the registered reference frame about one or more rotational degrees of freedom (e.g., zero roll and/or zero pitch), the method may include commanding at least one build plate actuator to move the build plate to adjust the pose to level the build plate plane. Returning to block 616, if the target portion is not disposed within the target three-dimensional volume, in block 618 it is determined whether at least one build plate actuator has sufficient travel range to move the build plate plane into the target three-dimensional volume. For example, in some cases the at least one actuator may be unable to adjust the pose to a sufficient degree that the target portion is fully disposed with in the target three-dimensional volume. In such cases, there may be an error in block 622, which may be communicated to a user (e.g., via an alert). Additionally, the method may be stopped in block 624, as if the build plate plane is not within the target three-dimensional volume, a product built on the build plate may fail or otherwise have diminished quality. If there is sufficient travel, in block 620 the at least one build plate actuator may be commanded to move the build plate such that the build plate plane is disposed within the target three-dimensional volume. The method may then continue to block 604.

In some embodiments, the method of FIGS. 17-18 may be performed by at least one processor. In some embodiments, kinematics may be employed to determine commands issued by the at least one processor to various actuators, including build plate actuators. In some embodiments, at least one processor may be configured to receive multiple measured points on a build plate and may compute a best fit plane. The at least one processor may further compute a normal vector from the best fit plane. The at least one processor may employ a dot product with the unit vector of the first degree of freedom (e.g., x-axis) to get a rotation about the second degree of freedom (e.g., y-axis). Similarly, the at least one processor may employ a dot product with the unit vector of the second degree of freedom (e.g., y-axis) to get a rotation about the first degree of freedom (e.g., x-axis). In this manner, changes in orientation and/or position of the build plate may be determined, and the appropriate actuators may be commanded to execute the desired movements.

FIG. 19 shows a block diagram for a method of operating an additive manufacturing system according to some embodiments. In some embodiments, the method of FIG. 19 may follow the method(s) of FIGS. 17-18. In block 630, a layer of material is deposited on a build plate. In block 632, a recoater blade is moved in a first degree of freedom relative to the build plate to smooth a build surface of the layer of material disposed on the build plate. In block 634, build surface distance information is obtained with one or more distance sensors (for example, see FIG. 13). The build surface distance information may include a relative distance between a reference frame of an optics assembly (or other reference frame of the additive manufacturing system) and the build surface. In some embodiments, the one or more distance sensors may obtain a plurality of distance measurements that represent three-dimensional points. In block 636 at least one build plate actuator is commanded to adjust a pose of a build surface based on the build surface distance information. An example of block 636 is discussed in detail with reference to FIG. 20. In optional block 638, a defect in the recoater blade is detected based at least partly on the build surface distance information. An example of block 638 is discussed in detail with reference to FIG. 21. In block 640, the optics assembly is moved in the first degree of freedom relative to the build surface. In some embodiments, the optics assembly may also move in a second degree of freedom perpendicular to the first degree of freedom. In some embodiments, the optics assembly and the recoater blade may be operatively coupled to the same horizontal motion stage (e.g., a rail). In block 642, laser energy is directed from one or more laser energy sources toward the build surface to melt at least a portion of the layer of material disposed on the build surface.

FIG. 20 shows a further block diagram for the method of operating an additive manufacturing system according to FIG. 19. Specifically, FIG. 20 shows exemplary steps associated with block 636 in FIG. 19. As shown in FIG. 20, the method may include, in block 644, receiving a plurality of distance measurements from one or more distance sensors representative of a relative distance between the reference frame of the optics assembly and a build surface. In block 646, the plurality of distance measurements may be fit to a line representative of a build surface plane. In some such embodiments, a build plate plane may have been previously measured. Accordingly, the method of FIG. 20 may be intended to align the build plate plane with an orientation of a recoater blade (e.g., make the build plate plane parallel to the fit line). In some embodiments, the plurality of distance measurements may be taken in a line parallel to a second degree of freedom perpendicular to the first degree of freedom. The plurality of distance measurements may include at least two points which may be best fit to a line. The fitting of the line may register the build surface plane to the reference frame of the additive manufacturing system. In other embodiments a plane may be fit, as the present disclosure is not so limited.

In block 648, the fit line is compared to a build plate plane. The build plate plane may have been previously registered, for example, by the method of FIG. 17. If the build plate plane and the line are aligned (e.g., the line is disposed in a plane parallel to the build plate plane), the method may continue to block 638 of FIG. 19. If the build plate plane and the line are not aligned, in block 650 is may be determined whether alignment would move the build surface or the build plate plane out of a target three-dimensional volume (e.g., a focus volume). If yes, there is an error 654 which may be communicated to a user. The method may also stop in block 656, as failure to align the build plate plane with the line (representative of an orientation of the recoater blade) may result in a non-uniform material thickness (for example, see FIG. 14). If no, the method may continue in block 652, where at least one build plate is moved by at least one build plate actuator that is commanded to align the build plate plane with the line and also maintain both the build plate plane and the build surface plane in the target three-dimensional volume. In some optional embodiments, a check similar to block 618 in FIG. 18 may also be completed prior to commanding the at least one build plate actuator to ensure the at least one build plate actuator has sufficient travel range to achieve the alignment. Following block 652 the method may continue with block 638.

In some embodiments, following the method of FIGS. 19-20, optionally the method may further include commanding the recoater blade to re-smooth the layer of material after the build plate plane is moved. After this re-smoothing, the method may be repeated to verify the movement was correct and the build plane is aligned (e.g., parallel to) the build surface plane after smoothing by the recoater blade.

FIG. 21 shows a further block diagram for the method of operating an additive manufacturing system according to FIG. 19. Specifically, FIG. 21 shows exemplary steps associated with block 638 in FIG. 19. In block 656, the method may include determining an error in the line fit from block 646 in FIG. 20. The error may be compared to an error threshold in block 658. If the error exceeds the threshold, a user may be alerted to a recoater blade defect in block 660. If the error does not exceed the threshold, the method may continue to block 640. In some embodiment's the errors of line fits and/or plane fits may be tracked over time to estimate the wear of components of the additive manufacturing system, and to identify defects in recoater blade or other abnormalities.

In some embodiments, the methods of FIGS. 19-21 may be performed by at least one processor.

The above method may be implemented by one or more controllers including at least one processor operatively coupled to the various controllable portions of an additive manufacturing system as disclosed herein. The method may be embodied as computer readable instructions stored on non-transitory computer readable memory associated with the at least one processor such that when executed by the at least one processor the additive manufacturing system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An additive manufacturing system comprising:
a build plate aligned with a build plate plane;
at least one build plate actuator operatively coupled to the build plate and configured to change a pose of the build plate plane;
one or more laser energy sources;
an optics assembly operatively movable in at least a first degree of freedom relative to the build plate, wherein the optics assembly is configured to direct laser energy from the one or more laser energy sources toward the build plate to melt at least a portion of a layer of material disposed on the build plate;
a recoater blade operatively movable in at least the first degree of freedom relative to the build plate, wherein the recoater blade is configured to smooth a build surface of the layer of material disposed on the build plate;
one or more distance sensors configured to obtain build plate distance information including a relative distance between a reference frame of the optics assembly and the build plate; and
at least one processor configured to:
receive the build plate distance information from the one or more distance sensors, and
command the at least one build plate actuator to adjust the pose of the build plate plane based at least partly on the build plate distance information.

2. The additive manufacturing system of claim 1, wherein the build plate distance information includes a plurality of distance measurements collected as the one or more distance sensors move in the first degree of freedom.

3. The additive manufacturing system of claim 2, wherein the at least one processor is configured to:
receive the plurality of distance measurements;
fit the plurality of distance measurements to a plane representative of the build plate plane;
determine whether a target portion of the build plate plane is disposed within a target three-dimensional volume; and
upon determining that the build plate plane is not disposed within the target three-dimensional volume, command the at least one build plate actuator to move the build plate such that the build plate plane is disposed within the target three-dimensional volume.

4. The additive manufacturing system of claim 3, wherein the target three-dimensional volume is a rectangular prism.

5. The additive manufacturing system of claim 4, wherein the rectangular prism has a height between 500 and 1250 microns.

6. The additive manufacturing system of claim 4, wherein the target three-dimensional volume is a focus volume of the optics assembly.

7. The additive manufacturing system of claim 3, wherein determining if the target portion of the plane is disposed within the target three-dimensional volume comprises:
determining positions of four edges of the build plate based on the fit plane; and
determining if the positions of the four edges are disposed within the target three-dimensional volume.

8. The additive manufacturing system of claim 2, wherein each of the plurality of distance measurements represents a point in three-dimensional space relative to the reference frame of the optics assembly.

9. The additive manufacturing system of claim 2, wherein the build plate distance information includes a plurality of distance measurements collected as the one or more distance sensors move in a second degree of freedom perpendicular to the first degree of freedom.

10. The additive manufacturing system of claim 1, wherein commanding the at least one build plate actuator to adjust the pose of the build plate plane comprises adjusting the pose of the build plate plane such that the build plate plane is parallel to the first degree of freedom.

11. The additive manufacturing system of claim 1, wherein commanding the at least one build plate actuator to adjust the pose of the build plate plane comprises rotating the build plate in a first rotational degree of freedom and a second rotational degree of freedom different than the first rotational degree of freedom.

12. The additive manufacturing system of claim 1, wherein the optics assembly and the recoater blade are both operatively coupled to a shared horizontal motion stage.

13. The additive manufacturing system of claim 1, wherein the one or more distance sensors are further configured to obtain build surface distance information including a relative distance between the reference frame of the optics assembly and a build surface of the layer of material, wherein the at least one processor is further configured to:
receive the build surface distance information from the one or more distance sensors, and
command the at least one build plate actuator to adjust the pose of the build plate plane based at least partly on the build surface distance information.

14. The additive manufacturing system of claim 1, wherein commanding the at least one build plate actuator to adjust the pose of the build plate plane based at least partly on the build plate distance information comprises:
determining whether the at least one build plate actuator has sufficient travel range to move the build plate plane into a target three-dimensional volume;
upon determining that the at least one build plate actuator has insufficient travel range, alerting a user to an error; and
upon determining that the at least one build plate actuator has sufficient travel range, controlling the at least one build plate actuator to move the build plate to adjust the pose of the build plate plane.

15. A method for additive manufacturing comprising:
obtaining, with one or more distance sensors, build plate distance information including a relative distance between a reference frame of an optics assembly and a build plate;
commanding, with at least one processor, at least one build plate actuator operatively coupled to the build plate to adjust a pose of a build plate plane aligned with the build plate based at least partly on the build plate distance information;
depositing a layer of material on the build plate;
moving a recoater blade operatively in a first degree of freedom relative to the build plate to smooth a build surface of the layer of material disposed on the build plate;
moving the optics assembly in the first degree of freedom relative to the build plate; and
directing laser energy from one or more laser energy sources toward the build plate to melt at least a portion of the layer of material disposed on the build plate.

16. The method of claim 15, wherein the build plate distance information includes a plurality of distance measurements collected as the one or more distance sensors move in the first degree of freedom.

17. The method of claim 16, further comprising, with the at least one processor:
receiving the plurality of distance measurements;
fitting the plurality of distance measurements to a plane representative of the build plate plane;
determining whether a target portion of the build plate plane is disposed within a target three-dimensional volume; and
upon determining that the build plate plane is not disposed within the target three-dimensional volume, commanding the at least one build plate actuator to move the build plate such that the build plate plane is disposed within the target three-dimensional volume.

18. The method of claim 17, wherein the target three-dimensional volume is a rectangular prism.

19. The method of claim 18, wherein the rectangular prism has a height between 500 and 1250 microns.

20. The method of claim 18, wherein the target three-dimensional volume is a focus volume of the optics assembly.

21. The method of claim 17, wherein determining if the target portion of the plane is disposed within the target three-dimensional volume comprises:
determining positions of four edges of the build plate based on the fit plane; and
determining if the positions of the four edges are disposed within the target three-dimensional volume.

22. The method of claim 16, wherein each of the plurality of distance measurements represents a point in three-dimensional space relative to the reference frame of the optics assembly.

23. The method of claim 16, wherein the build plate distance information includes a plurality of distance measurements collected as the one or more distance sensors move in a second degree of freedom perpendicular to the first degree of freedom.

24. The method of claim 15, wherein commanding the at least one build plate actuator to adjust the pose of the build plate plane comprises adjusting the pose of the build plate plane such that the build plate plane is parallel to the first degree of freedom.

25. The method of claim 15, wherein commanding the at least one build plate actuator to adjust the pose of the build plate plane comprises rotating the build plate in a first rotational degree of freedom and a second rotational degree of freedom different than the first rotational degree of freedom.

26. The method of claim 15, wherein the optics assembly and the recoater blade are both operatively coupled to a shared horizontal motion stage.

27. The method of claim 15, further comprising:
obtaining, with the one or more distance sensors, build surface distance information including a relative distance between the reference frame of the optics assembly and the build surface of the layer of material;
receiving the build surface distance information from the one or more distance sensors; and
commanding the at least one build plate actuator to adjust the pose of the build plate plane based at least partly on the build surface distance information.

28. The method of claim 15, wherein commanding the at least one build plate actuator to adjust the pose of the build plate plane based at least partly on the build plate distance information comprises:
determining whether the at least one build plate actuator has sufficient travel range to move the build plate plane into a target three-dimensional volume;
upon determining that the at least one build plate actuator has insufficient travel range, alerting a user to an error; and
upon determining that the at least one build plate actuator has sufficient travel range, controlling the at least one build plate actuator to move the build plate to adjust the pose of the build plate plane.

29. The method of claim 15, further comprising additively building a product with the build plate, the recoater blade, and the optics assembly after adjusting the pose of the build plate plane.

30. The method of claim 29, wherein additively building the product comprises fusing the melted portion of the layer of material to form the product on the build plate.

31. A product built using the method of claim 15.

32. An additive manufacturing system comprising:
a build plate aligned with a build plate plane, wherein the build plate is configured to receive a layer of material;
at least one build plate actuator operatively coupled to the build plate and configured to change a pose of the build plate plane;
one or more laser energy sources;
an optics assembly movable in at least a first degree of freedom relative to the build plate, wherein the optics assembly is configured to direct laser energy from the one or more laser energy sources toward the build plate to melt at least a portion of the layer of material disposed on the build plate;
a recoater blade movable in at least the first degree of freedom relative to the build plate, wherein the recoater blade is configured to smooth a build surface of the layer of material disposed on the build plate;
one or more distance sensors configured to obtain build surface distance information including a relative distance between a reference frame of the optics assembly and a build surface of the layer of material; and
at least one processor configured to:
receive the build surface distance information from the one or more distance sensors, and
command the at least one build plate actuator to adjust the pose of the build plate plane based at least partly on the build surface distance information.

33.-42. (canceled)

43. A method for additive manufacturing comprising:
depositing a layer of material on a build plate;
moving a recoater blade in a first degree of freedom relative to the build plate to smooth a build surface of the layer of material disposed on the build plate;
obtaining, with one or more distance sensors, build surface distance information including a relative distance between a reference frame of an optics assembly and the build surface;
commanding, with at least one processor, at least one build plate actuator operatively coupled to the build plate to adjust a pose of a build plate plane aligned with the build plate based at least partly on the build surface distance information;
moving the optics assembly in the first degree of freedom relative to the build plate; and
directing laser energy from one or more laser energy sources toward the build plate to melt at least a portion of the layer of material disposed on the build plate.

44.-55. (canceled)

56. A method for additive manufacturing comprising:
obtaining, with one or more distance sensors, deck distance information including a relative distance between a reference frame of an optics assembly and a deck surface;
adjusting a first height of a first end of a recoater blade based on the deck distance information;
adjusting a second height of a second opposing end of the recoater blade based on the deck distance information; and
locking the recoater blade in position relative to the reference frame after adjusting the first height and the second height such that a lower edge of the recoater blade is disposed in a focus volume of the optics assembly.

57.-64. (canceled)

65. At least one non-transitory computer-readable storage medium storing programming instructions that, when executed by at least one processor, causes the at least one processor to perform the method of claim 15.

66.-67. (canceled)
